(19) United States
(12) Patent Application Publication
(10) Pub. No.: US 2020/0259137 A1
(43) Pub. Date: Aug. 13, 2020

(54) CURABLE COMPOSITIONS, ARTICLES THEREFROM, AND METHODS OF MAKING AND USING SAME

(71) Applicant: 3M INNOVATIVE PROPERTIES COMPANY, St. Paul, MN (US)

(72) Inventors: Li Yao, Woodbury, MN (US); Rajdeep S. Kalgutkar, Woodbury, MN (US); Mario A. Perez, Burnsville, MN (US); Jeremy M. Higgins, Roseville, MN (US); Taesung Kim, Woodbury, MN (US); Brett A. Beiermann, St. Paul, MN (US)

(21) Appl. No.: 16/753,897

(22) PCT Filed: Oct. 3, 2018
(86) PCT No.: PCT/US2018/054117

§ 371 Date: Apr. 6, 2020

Related U.S. Application Data
(60) Provisional application No. 62/569,100, filed on Oct. 6, 2017.

(51) Int. Cl. H01M 2/10; C08G 59/54; C09K 5/14; C09J 163/00; C09J 9/00; H01M 10/653; H01M 10/625

(52) U.S. Cl. CPC H01M 2/1077; C08G 59/54; C09K 5/14; H01M 2220/20; C09J 9/00; H01M 10/653; H01M 10/625; C09J 163/00

(57) ABSTRACT

A curable composition includes a polyamide composition comprising a polyamide. The polyamide comprises a tertiary amide in the backbone thereof and is amine terminated. The curable composition also comprises an epoxy composition that includes an epoxy resin.

### FIELD

The present invention generally relates to curable compositions that include an epoxy composition and a polyamide composition. The curable compositions may be used, for example, as thermally conductive gap fillers, which may be suitable for use in electronic applications such as battery assemblies.

### BACKGROUND

Curable compositions based on epoxy or polyamide resins have been disclosed in the art. Such curable compositions are described in, for example, U.S. Pat. No. 2,705,223 and U.S. Pat. No. 6,008,313.

### SUMMARY

In some embodiments, a curable composition is provided. The curable composition includes a polyamide composition comprising a polyamide. The polyamide comprises a tertiary amide in the backbone thereof and is amine terminated. The curable composition also includes an epoxy composition that includes an epoxy resin.

In some embodiments, a curable composition is provided. The curable composition includes a polyamide composition that includes a first polyamide component and a second polyamide component. The first polyamide component comprises the reaction product a diacid and a diamine. The diamine comprises a secondary diamine or a secondary/primary hybrid diamine. The first polyamide component comprises a tertiary amide in the backbone thereof and is amine terminated. The curable composition also includes an epoxy composition comprising an epoxy resin.

In some embodiments, a curable composition is provided. The curable composition includes a polyamide, an epoxy resin, and an inorganic filler. The inorganic filler is present in the curable composition in an amount of at least 20 volume %, based on the total volume of the curable composition. The curable composition provides, upon curing, (i) an elongation at break of greater than 5.5%, and (ii) an overlap shear strength of 5-20 N/mm².

As used herein:

The term “room temperature” refers to a temperature of 22° C. to 25° C.

The terms “cure” and “curable” refer to joining polymer chains together by covalent chemical bonds, usually via crosslinking molecules or groups, to form a network polymer. Therefore, in this disclosure the terms “cured” and “crosslinked” may be used interchangeably. A cured or crosslinked polymer is generally characterized by insolubility, but may be swellable in the presence of an appropriate solvent.

The term “backbone” refers to the main continuous chain of a polymer.

The term “aliphatic” refers to C1-C40, suitably C1-C30, straight or branched chain alkenyl, alkyl, or alkynyl which may or may not be interrupted or substituted by one or more heteroatoms such as O, N, or S.

The term “cycloaliphatic” refers to cyclized aliphatic C3-C30, suitably C3-C20, groups and includes those interrupted by one or more heteroatoms such as O, N, or S.

The term “alkyl” refers to a monovalent group that is a radical of an alkane and includes straight-chain, branched, cyclic, and bicyclic alkyl groups, and combinations thereof, including both unsubstituted and substituted alkyl groups. Unless otherwise indicated, the alkyl groups typically contain from 1 to 30 carbon atoms. In some embodiments, the alkyl groups contain 1 to 20 carbon atoms, I to 10 carbon atoms, 1 to 6 carbon atoms, 1 to 4 carbon atoms, or 1 to 3 carbon atoms. Examples of “alkyl” groups include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, adamantyl, norbornyl, and the like.

The term “alkylene” refers to a divalent group that is a radical of an alkane and includes groups that are linear, branched, cyclic, bicyclic, or a combination thereof Unless otherwise indicated, the alkylene group typically has 1 to 30 carbon atoms. In some embodiments, the alkylene group has 1 to 20 carbon atoms, 1 to 10 carbon atoms, 1 to 6 carbon atoms, or 1 to 4 carbon atoms. Examples of “alkylene” groups include methylene, ethylene, 1,3-propylene, 1,2-propylene, 1,4-butylene, 1,4-cyclohexylene, and 1,4-cyclohexyldimethylene.

The term “aromatic” refers to C3-C40, suitably C3-C30, aromatic groups including both carbocyclic aromatic groups as well as heterocyclic aromatic groups containing one or more of the heteroatoms, O, N, or S, and fused ring systems containing one or more of these aromatic groups fused together.

The term “aryl” refers to a monovalent group that is aromatic and, optionally, carbocyclic. The aryl has at least one aromatic ring. Any additional rings can be unsaturated, partially saturated, saturated, or aromatic. Optionally, the aromatic ring can have one or more additional carbocyclic rings that are fused to the aromatic ring. Unless otherwise indicated, the aryl groups typically contain from 6 to 30 carbon atoms. In some embodiments, the aryl groups contain 6 to 20, 6 to 18, 6 to 16, 6 to 12, or 6 to 10 carbon atoms. Examples of an aryl group include phenyl, naphthyl, biphenyl, phenanthryl, and anthracyl.

The term “arylene” refers to a divalent group that is aromatic and, optionally, carbocyclic. The arylene has at least one aromatic ring. Optionally, the aromatic ring can have one or more additional carbocyclic rings that are fused to the aromatic ring. Any additional rings can be unsaturated, partially saturated, or saturated. Unless otherwise specified, arylene groups often have 6 to 20 carbon atoms, 6 to 18 carbon atoms, 6 to 16 carbon atoms, 6 to 12 carbon atoms, or 6 to 10 carbon atoms.

The term “aralkyl” refers to a monovalent group that is an alkyl group substituted with an aryl group (e.g., as in a benzyl group). The term “alkaryl” refers to a monovalent group that is an aryl substituted with an alkyl group (e.g., as in a tolyl group). Unless otherwise indicated, for both groups, the alkyl portion often has 1 to 10 carbon atoms, 1 to 6 carbon atoms, or 1 to 4 carbon atoms and an aryl portion often has 6 to 20 carbon atoms, 6 to 18 carbon atoms, 6 to 16 carbon atoms, 6 to 12 carbon atoms, or 6 to 10 carbon atoms.

Repeated use of reference characters in the specification is intended to represent the same or analogous features or elements of the disclosure. As used herein, the word “between”, as applied to numerical ranges, includes the endpoints of the ranges, unless otherwise specified. The recitation of numerical ranges by endpoints includes all numbers within that range (e.g. 1 to 5 includes 1, 1.5, 2, 2.75, 3, 3.80, 4, and 5) and any range within that range.

It should be understood that numerous other modifications and embodiments can be devised by those skilled in the art, which fall within the scope and spirit of the principles of the disclosure. All scientific and technical terms used herein have meanings commonly used in the art unless otherwise specified. The definitions provided herein are to facilitate understanding of certain terms used frequently herein and are not meant to limit the scope of the present disclosure. As used in this specification and the appended claims, the singular forms “a”, “an”, and “the” encompass embodiments having plural referents, unless the context clearly dictates otherwise. As used in this specification and the appended claims, the term “or” is generally employed in its sense including “and/or” unless the context clearly dictates otherwise.

### BRIEF DESCRIPTION OF THE DRAWINGS

FIG. 1 illustrates the assembly of an exemplary battery module according to some embodiments of the present disclosure.

FIG. 2 illustrates the assembled battery module corresponding to FIG. 1.

FIG. 3 illustrates the assembly of an exemplary battery subunit according to some embodiments of the present disclosure.

### DETAILED DESCRIPTION

Thermal management plays an important role in many electronics applications such as, for example, electric vehicle (EV) battery assembly, power electronics, electronic packaging, LED, solar cells, electric grid, and the like. Certain thermally conductive materials (e.g., adhesives) may be an attractive option for these applications due to good electrical insulative properties, feasibility in processing for integrated parts or complex geometries, and good conformability/wettability to different surfaces, especially the ability to efficiently dissipate the heat away while having good adhesion to different substrates for assembly.

Regarding applications in EV battery assemblies, currently, one such application that utilizes a thermally conductive material is the gap filler application. Generally, requirements for the gap filler application include high thermally conductivity, good overlap shear adhesion strength, good tensile strength, good elongation at break for toughness, and good damping performance, in addition to having low viscosity before curing. However, to achieve high thermal conductivity, typically, a large amount of inorganic thermally conductive filler is added to the composition. The high loading of thermally conductive fillers, however, has a deleterious impact on adhesion performance, toughness, damping performance, and viscosity.

Many current compositions employed in the EV thermal adhesive gap filler application are based on polyurethane curing chemistries. While these polyurethane based materials can exhibit properties that render them suitable as gap filler materials, the isocyanates used in such products pose safety concerns as well as poor stability at elevated temperatures.

In order to solve the above-discussed problems associated with high loadings of inorganic thermally conductive filler and the safety concerns associated with polyurethane based compositions, a curable composition providing a good balance of the desired properties has been discovered that includes an epoxy composition and a polyamide composition, the polyamide composition including a polyamide having one or more tertiary amides in the backbone thereof. The polyamides of this curable composition may be branched, amorphous, and promote hydrogen bonding which can enhance adhesion in the presence of high filler loading. The unique combination of polyamides of the present disclosure has advantages over polyurethane for these applications at least because (i) they are isocyanate-free compositions that do not interfere with environmental regulations, (ii) they provide better compatibility with various thermally conductive fillers, (iii) they provide superior adhesion to aluminum and steel substrates.

In some embodiments, the present disclosure provides a highly filler loaded thermally conductive curable composition, formulated by blending a polyamide composition and an epoxy composition, that provides exceptional tensile strength, elongation at break, and overlap shear strength, as well as exceptional adhesion to bare aluminum and steel substrates. In some embodiments, the polyamides of the present disclosure may contain tertiary amides in the backbone, which may enhance elongation at break at room temperature by reducing the volume density of hydrogen bonding and crosslinking and providing chain flexibility, while maintaining good adhesion to metallic substrates. In some embodiments, to reduce viscosity when high filler loadings are used, the structure and molecular weight of the polyamides may also be adjusted. Polyamide-compatible dispersants may also be added to further reduce compound viscosity.

In some embodiments, the curable compositions of the present disclosure may include an epoxy composition and a polyamide composition, the polyamide composition including one or more polyamides having one or more tertiary amides in the backbone thereof.

In some embodiment, the epoxy compositions may include one or more epoxy resins. Suitable epoxy resins epoxies may include aromatic polyepoxide resins (e.g., a chain-extended diepoxide or novolac epoxy resin having at least two epoxide groups), aromatic monomeric diepoxides, aliphatic polyepoxide, ormonomeric diepoxides. A crosslinkable epoxy resin typically will have at least two epoxy end groups. The aromatic polyepoxide or aromatic monomeric diepoxide typically contains at least one (in some embodiments, at least 2, in some embodiments, in a range from 1 to 4) aromatic ring that is optionally substituted by a halogen (e.g., fluoro, chloro, bromo, iodo), alkyl having 1 to 4 carbon atoms (e.g., methyl or ethyl), or hydroxyalkyl having 1 to 4 carbon atoms (e.g., hydroxymethyl). For epoxy resins containing two or more aromatic rings, the rings may be connected, for example, by a branched or straight-chain alkylene group having 1 to 4 carbon atoms that may optionally be substituted by halogen (e.g., fluoro, chloro, bromo, iodo).

In some embodiments, examples of aromatic epoxy resins useful in the epoxy compositions disclosed herein may include novolac epoxy resins (e.g., phenol novolacs, ortho-, meta-, or para-cresol novolacs or combinations thereof), bisphenol epoxy resins (e.g., bisphenol A, bisphenol F, halogenated bisphenol epoxies, and combinations thereof), resorcinol epoxy resins, tetrakis phenylolethane epoxy resins and combinations of any of these. Useful epoxy compounds include diglycidyl ethers of difunctional phenolic compounds (e.g., p,p′-dihydroxydibenzyl, p,p′-dihydroxydiphenyl, p,p′-dihydroxyphenyl sulfone, p,p′-dihydroxybenzophenone, 2,2′-dihydroxy-1,1-dinaphthylmethane, and the 2,2′, 2,3′, 2,4′, 3,3′, 3,4′, and 4,4′ isomers of dihydroxydiphenylmethane, dihydroxydiphenyldimethylmethane, dihydroxydiphenylethylmethylmethane, dihydroxydiphenylmethylpropylmethane, dihydroxydiphenylethylphenylmethane, dihydroxydiphenylpropylphenylmethane, dihydroxydiphenylbutylphenylmethane, dihydroxydiphenyltolylethane, dihydroxydiphenyltolylmethylmethane, dihydroxydiphenyldicyclohexylmethane, and dihydroxydiphenylcyclohexane.) In some embodiments, the adhesive includes a bisphenol diglycidyl ether, wherein the bisphenol (i.e., —O—C₆H₅—CH₂—C₆H₅—O—) may be unsubstituted (e.g., bisphenol F), or either of the phenyl rings or the methylene group may be substituted by one or more halogens (e.g., fluoro, chloro, bromo, iodo), methyl groups, trifluoromethyl groups, or hydroxymethyl groups.

In some embodiments, examples of aromatic monomeric diepoxides useful in the epoxy compositions according to the present disclosure include the diglycidyl ethers of bisphenol A and bisphenol F and mixtures thereof. Bisphenol epoxy resins, for example, may be chain extended to have any desirable epoxy equivalent weight. Chain extending epoxy resins can be carried out by reacting a monomeric diepoxide, for example, with a bisphenol in the presence of a catalyst to make a linear polymer.

In some embodiments, the aromatic epoxy resin (e.g., either a bisphenol epoxy resin or a novolac epoxy resin) may have an epoxy equivalent weight of at least 150, 170, 200, or 225 grams per equivalent. In some embodiments, the aromatic epoxy resin may have an epoxy equivalent weight of up to 2000, 1500, or 1000 grams per equivalent. In some embodiments, the aromatic epoxy resin may have an epoxy equivalent weight in a range from 150 to 2000, 150 to 1000, or 170 to 900 grams per equivalent. In some embodiments, the first epoxy resin has an epoxy equivalent weight in a range from 150 to 450, 150 to 350, or 150 to 300 grams per equivalent. Epoxy equivalent weights may be selected, for example, so that the epoxy resin may be used as a liquid or solid, as desired.

In some embodiments, in addition or as an alternative to aromatic epoxy resins, the epoxy resins of the present disclosure may include one or more non-aromatic epoxy resins. In some cases, non-aromatic epoxy resins can be useful as reactive diluents that may help control the flow characteristics of the compositions. Non-aromatic epoxy resins useful in the curable compositions according to the present disclosure can include a branched or straight-chain alkylene group having 1 to 20 carbon atoms optionally interrupted with at least one —O— and optionally substituted by hydroxyl. In some embodiments, the non-aromatic epoxy can include a poly(oxyalkylene) group having a plurality (x) of oxyalkylene group C₂ to C₃ alkylene, x is 2 to about 6, 2 to 5, 2 to 4, or 2 to 3. To become crosslinked into a network, useful non-aromatic epoxy resins will typically have at least two epoxy end groups. Examples of useful non-aromatic epoxy resins include glycidyl epoxy resins such as those based on diglycidyl ether compounds comprising one or more oxyalkylene units. Examples of these include resins made from ethylene glycol diglycidyl ether, propylene glycol diglycidyl ether, diethylene glycol diglycidyl ether, dipropylene glycol diglycidyl ether, polyethylene glycol diglycidyl ether, polypropylene glycol diglycidyl ether, glycerol diglycidyl ether, glycerol triglycidyl ether, propanediol diglycidyl ether, butanediol diglycidyl ether, and hexanediol diglycidyl ether. Other useful non-aromatic epoxy resins include a diglycidyl ether of cyclohexane dimethanol, a diglycidyl ether of neopentyl glycol, a triglycidyl ether of trimethylolpropane, and a diglycidyl ether of 1,4-butanediol.

Crosslinked aromatic epoxies (that is, epoxy polymers) as described herein can be understood to be preparable by crosslinking aromatic epoxy resins. The crosslinked aromatic epoxy typically contains a repeating unit with at least one (in some embodiments, at least 2, in some embodiments, in a range from 1 to 4) aromatic ring (e.g., phenyl group) that is optionally substituted by one or more halogens (e.g., fluoro, chloro, bromo, iodo), alkyl groups having 1 to 4 carbon atoms (e.g., methyl or ethyl), or hydroxyalkyl groups having 1 to 4 carbon atoms (e.g., hydroxymethyl). For repeating units containing two or more aromatic rings, the rings may be connected, for example, by a branched or straight-chain alkylene group having 1 to 4 carbon atoms that may optionally be substituted by halogen (e.g., fluoro, chloro, bromo, iodo).

In some embodiments, the epoxy resins of the present disclosure may be liquid at room temperature. Several curable epoxy resins useful in the epoxy compositions according to the present disclosure may be commercially available. For example, several epoxy resins of various classes and epoxy equivalent weights are available from Dow Chemical Company, Midland, Mich.; Momentive Specialty Chemicals, Inc., Columbus, Ohio; Huntsman Advanced Materials, The Woodlands, Tex.; CVC Specialty Chemicals Inc. Akron, Ohio (acquired by Emerald Performance Materials); and Nan Ya Plastics Corporation, Taipei City, Taiwan. Examples of commercially available glycidyl ethers include diglycidylethers of bisphenol A (e.g. those available under the trade designations “EPON 828”, “EPON 1001”, “EPON 1310” and “EPON 1510” from Hexion Specialty Chemicals GmbH, Rosbach, Germany, those available under the trade designation “D.E.R.” from Dow Chemical Co. (e.g., D.E.R. 331, 332, and 334), those available under the trade designation “EPICLON” from Dainippon Ink and Chemicals, Inc. (e.g., EPICLON 840 and 850) and those available under the trade designation “YL-980” from Japan Epoxy Resins Co., Ltd.); diglycidyl ethers of bisphenol F (e.g. those available under the trade designation “EPICLON” from Dainippon Ink and Chemicals, Inc. (e.g., “EPICLON 830”)); polyglycidyl ethers of novolac resins (e.g., novolac epoxy resins, such as those available under the trade designation “D.E.N.” from Dow Chemical Co. (e.g., D.E.N. 425, 431, and 438)); and flame retardant epoxy resins (e.g., “D.E.R. 580”, a brominated bisphenol type epoxy resin available from Dow Chemical Co.). Examples of commercially available non-aromatic epoxy resins include the glycidyl ether of cyclohexane dimethanol, available from Hexion Specialty Chemicals GmbH, under the trade designation “HELOXY MODIFIER 107”.

In some embodiments, the epoxy compositions of the present disclosure may include epoxy resin in an amount of between 5 wt. % and 40 wt. %, 10 wt. % and 30 wt. %, 15 wt. % and 30 wt. %, or 20 wt. % and 30 wt. % (or may be even higher (up to 95%, 99%, or 100%) for curable compositions that do not include fillers), based on the total weight of the epoxy composition. In some embodiments, the epoxy compositions of the present disclosure may include epoxy resin in an amount of at least 10 wt. %, at least 20 wt. %, at least 30 wt. %, at least 40 wt. %, or at least 50 wt. %, based on the total weight of the epoxy composition.

In some embodiments, the polyamide composition may include a first polyamide component and a second polyamide component.

In some embodiments, the first polyamide component may include one or more polyamides that include one or more tertiary amides in the backbone thereof. In some embodiments, the tertiary polyamides may be present in the backbone of the polyamides in an amount of 50-100 mol %, 70-100 mol %, 90-100 mol %, 50-99 mol %, 70-99 mol %, 90-99 mol %, 95-100 mol %, or 95-99 mol %, or 99-100 mol %, based on the total amide content present in the polyamide backbone. In some embodiments, the tertiary polyamides may be present in the backbone of the polyamides in an amount of at least 50 mol %, at least 70 mol %, at least 90 mol %, at least 95 mol %, or at least 99 mol %, based on the total amide content present in the polyamide backbone. Generally, it is believed that the presence of such tertiary amides enhances elongation at break at room temperature by reducing the volume density of hydrogen bonding and crosslinking, while maintaining good adhesion to metallic substrates.

The polyamides of the first polyamide component may, in addition to the tertiary amides, include secondary amides in the backbone thereof. The polyamides of the first polyamide component may be amine terminated, including primary and secondary amine terminated.

In some embodiments, the polyamides of the first polyamide component may be liquid (e.g., a viscous liquid having a viscosity of about 500-50,000 cP) at room temperature.

In some embodiments, the polyamides of the first polyamide component may include the reaction product (e.g., by condensation polymerization) of a diacid component and a diamine component.

In some embodiments, the diacid component may include any long chain diacid (e.g., diacids that include greater than 15 carbon atoms). The diacid component may further include a short chain diacid (e.g., diacids that include between 2 and 15 carbon atoms). In some embodiments, the long chain diacid may be present in the diacid component in an amount of between 80-100 mol %, 85-100 mol %, 90-100 mol %, 95-100 mol %, 80-99 mol. %, or 80-95 mol. %; or at least 80 mol. %, at least 90 mol. %, or at least 95 mol. %, based on the total moles of the diacid component. In some embodiments, the short chain diacid may not be present in the diacid component, or may be present in the diacid component in an amount of between 1-20 mol %, 1-15 mol %, 1-10 mol %, or 1-5 mol. %, based on the total moles of the diacid component.

In some embodiments, the diacid component may include a dicarboxylic acid (e.g., in the form of a dicarboxylic dimer acid). In some embodiments, the dicarboxylic acid may include at least one alkyl or alkenyl group and may contain 3 to 30 carbon atoms and may be characterized by having two carboxylic acid groups. The alkyl or alkenyl group may be branched. The alkyl group may be cyclic. Useful dicarboxylic acids may include propanedioic acid, butanedioic acid, pentanedioic acid, hexanedioic acid, heptanedioic acid, octanedioic acid, nonanedioic acid, decanedioic acid, undecanedioic acid, dodecanedioic acid, hexadecanedioic acid, (Z)-Butenedioic acid, (E)-Butenedioic acid, pent-2-enedioic acid, dodec-2-enedioic acid, (2Z)-2-Methylbut-2-enedioic acid, (2E,4E)-Hexa-2,4-dienedioic acid, sebacic acid. Aromatic dicarboxylic acids may be used, such as phthalic acid, isophthalic acid, terephthalic acid and 2,6-naphthalenedicarboxylic acidMixtures of two or more dicarboxylic acid may be used, as mixtures of different dicarboxylic acids may aid in disrupting the structural regularity of the polyamide, thereby significantly reducing or eliminating crystallinity in the resulting polyamide component.

In some embodiments, the dicarboxylic dimer acid may include at least one alkyl or alkenyl group and may contain 12 to 100 carbon atoms, 16 to 100 carbon atoms, or 18 to 100 carbon atoms and is characterized by having two carboxylic acid groups. The dimer acid may be saturated or partially unsaturated. In some embodiments, the dimer acid may be a dimer of a fatty acid. The phrase “fatty acid,” as used herein means an organic compound composed of an alkyl or alkenyl group containing 5 to 22 carbon atoms and characterized by a terminal carboxylic acid group. Useful fatty acids are disclosed in “Fatty Acids in Industry: Processes, Properties, Derivatives, Applications”, Chapter 7, pp 153-175, Marcel Dekker, Inc., 1989. In some embodiments, the dimer acid may be formed by the dimerization of unsaturated fatty acids having 18 carbon atoms such as oleic acid or tall oil fatty acid. The dimer acids are often at least partially unsaturated and often contain 36 carbon atoms. The dimer acids may be relatively high molecular weight and made up of mixtures comprising various ratios of a variety of large or relatively high molecular weight substituted cyclohexenecarboxylic acids, predominately 36-carbon dicarboxylic dimer acid. Component structures may be acyclic, cyclic (monocyclic or bicyclic) or aromatic, as shown below.

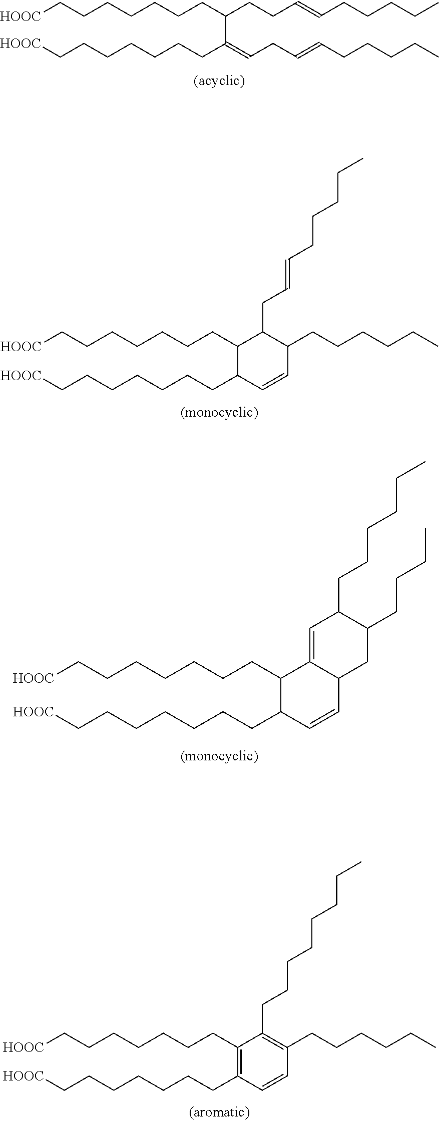 [SMILES: CCCCC/C=C/C/C=C(/CCCCCCCC(=O)O)C(CC/C=C/CCCCC)CCCCCCCC(=O)O ; CCCCC/C=C/CC1C(CCCCCC)C=CC(CCCCCCCC(=O)O)C1CCCCCCCC(=O)O ; CCCCCCC1C=C2C(C=CC(CCCCCCCC(=O)O)C2CCCCCCCC(=O)O)CC1CCCC ; CCCCCCCCc1c(CCCCCC)ccc(CCCCCCCC(=O)O)c1CCCCCCCC(=O)O]

The dimer acids may be prepared by condensing unsaturated monofunctional carboxylic acids such as oleic, linoleic, soya or tall oil acid through their olefinically unsaturated groups, in the presence of catalysts such as acidic clays. The distribution of the various structures in dimer acids (nominally C36 dibasic acids) depends upon the unsaturated acid used in their manufacture. Typically, oleic acid gives a dicarboxylic dimer acid containing about 38% acyclics, about 56% mono- and bicyclics, and about 6% aromatics. Soya acid gives a dicarboxylic dimer acid containing about 24% acyclics, about 58% mono- and bicyclics and about 18% aromatics. Tall oil acid gives a dicarboxylic dimer acid containing about 13% acyclics, about 75% mono- and bicyclics and about 12% aromatics. The dimerization procedure also produces trimer acids. The commercial dimer acid products are typically purified by distillation to produce a range of dicarboxylic acid content. Useful dimer acids contain at least 80% dicarboxylic acid, more preferably 90% dicarboxylic acid content, even more preferably at least 95% dicarboxylic acid content. For certain applications, it may be advantageous to further purify the dimer acid by color reduction techniques including hydrogenation of the unsaturation, as disclosed in U.S. Pat. No. 3,595,887, which is incorporate herein by reference in its entirety. Hydrogenated dimer acids may also provide increased oxidative stability at elevated temperatures. Other useful dimer acids are disclosed in Kirk-Othmer Encyclopedia of Chemical Technology, Organic Chemicals: Dimer Acids (ISBN 9780471238966), copyright 1999-2014, John Wiley and Sons, Inc. Commercially available dicarboxylic dimer acids are available under the trade designation EMPOL1008 and EMPOL1061 both from BASF, Florham Park, N.J. and PRIPOL 1006, PRIPOL 1009, PRIPOL 1013, PRIPOL 1017 and PRIPOL 1025 all from Croda Inc., Edison, N.J., for example.

In some embodiments, the number average molecular weight of the dicarboxylic dimer acid may be between from 300 g/mol to 1400 g/mol, between from 300 g/mol to 1200 g/mol, between from 300 g/mol to 1000 g/mol or even between from 300 g/mol to 800 g/mol. In some embodiments, the number of carbon atoms in the dicarboxylic dimer acid may be between from 12 to 100, between from 20 to 100, between from 30 to 100, between from 12 to 80, between from 20 to 80, between from 30 to 80, between from 12 to 60, between from 20 to 60 or even between from 30 to 60. The mole fraction of dicarboxylic dimer acid included as the dicarboxylic acid may be between from 0.10 to 1.00, based on the total moles of dicarboxylic acid used to form the polyamide component. In some embodiments the, mole fraction of dicarboxylic dimer acid included as the dicarboxylic acid, is between from 0.10 to 1.00, between from 0.30 to 1.00, between from 0.50 to 1.00, between from 0.70 to 1.00, between from 0.80 to 1.00, between from 0.90 to 1.00, between from 0.10 to 0.98, between from 0.30 to 0.98, between from 0.50 to 0.98, between from 0.70 to 0.98, between from 0.80 to 0.98, or even between from 0.90 to 0.98, based on the total moles of dicarboxylic acid used to form the polyamide component. In some embodiments, the mole fraction of dicarboxylic dimer acid included as the dicarboxylic acid is 1.00, based on the total moles of dicarboxylic acid used to form the polyamide component. Mixtures of two or more dimer acids may be used.

In some embodiments, the diamine component may include one or more secondary diamines or one or more secondary/primary hybrid diamines and, optionally, one or more primary diamines.

In some embodiments, suitable secondary or secondary/primary hybrid amines may have the formula: R1-NH-R2-NH-R1

where R2 is an:

alkylene (e.g. —CH2CH2CH2-),

branched alkylene (—CH2CH(Me)CH2-),

cycloalkylene (e.g. -cyclohexyl-CH2-cyclohexyl-),

substituted or unsubstituted arylene (e.g. -1,4-Phenylene-),

heteroalkylene (e.g. —CH2CH2-O—CH2CH2- or any other Jeffamine), or

heterocycloalkylene (e.g. —CH2-furan ring-CH2-)

and each R1, independently, is a:

linear or branched alkyl (e.g. -Me, -isopropyl),

cycloalkyl (e.g. -cyclohexyl),

aryl (e.g. -phenyl),

heteroalkyl (e.g. —CH2CH2-O—CH3),

heteroaryl (e.g., -2-substituted-pyridyl), or

hydrogen atom,

with the proviso that both Rls are not hydrogen atoms, or
the R1 groups are alkylene or branched alkylene and form a heterocyclic compound (e.g. piperazine)

Suitable secondary diamines may include, for example, piperazine, 1,3-Di-4-piperidylpropane, cyclohexanamine, 4,4′-methylenebis[N-(1-methylpropyl). In some embodiments, suitable secondary/primary hybrid diamines (i.e., diamines having a secondary amine and a primary amine) include, for example, aminoethyl piperazine. In some embodiments, the secondary/primary hybrid diamines may not be present, or may be present in an amount of less than 50 mol. %, less than 30 mol. %, less than 10 mol. %, or less than 5 mol. %, based on the total moles of the secondary or secondary/primary hybrid amines. In some embodiments, the number average molecular weight of suitable secondary diamines or secondary/primary hybrid diamines may be from 30 g/mol to 5000 g/mol, 30 g/mol to 500 g/mol, or 50 g/mol to 100 g/mol.

In some embodiments, the diamine component may, in addition to the secondary or secondary/primary hybrid amine, include a primary diamine, such as an aliphatic or aromatic primary amine. Suitable primary amines include, for example, ethylenediamine, m-xylylenediamine, 1,6-hexanediamine, o-toluidine, or 1,3-Benzenedimethanamine. In some embodiments, the number average molecular weight of suitable primary diamines may be from 30 g/mol to 5000 g/mol, 30 g/mol to 500 g/mol, or 50 g/mol to 100 g/mol.

In some embodiments, the secondary or secondary/primary hybrid diamines, alone or in combination, may be present in the diamine component in an amount of from 50-100 mol %, 70-100 mol %, 90-100 mol %, 50-99 mol %, 70-99 mol %, 90-99 mol %, 95 -100 mol %, or 95-99 mol %, or 99-100 mol %, based on the total moles of the diamine component. In some embodiments, the secondary or secondary/primary hybrid diamines, alone or in combination, may be present in the diamine component in an amount of in an amount of at least 50 mol %, at least 70 mol %, at least 90 mol %, at least 95 mol %, or at least 99 mol %, based on the total moles of the diamine component.

In some embodiments, primary amines may not be present in the diamine component, or may be present in the diamine component in an amount of between 1-10 mol % or 1-5 mol %, based on the total moles of the diamine component. In some embodiments, the mole ratio of diamine to diacid in the first polyamide component may be between 1 and 5, 1 and 4, 1.1 and 4, or 1.2 and 3.

In some embodiments, the polyamides of the first polyamide component may be formed following a conventional condensation reaction between at least one of the above described diacids and at least one of the above described diamines. Mixtures of at least two diacid types with at least one diamine, mixtures of at least two diamine types with at least one diacid type, or mixtures of at least two diacid types with at least two diamine types may be used. The polyamides of the first polyamide component may be amine terminated or include amine end-groups. Amine termination can be obtained by using the appropriate stoichiometric ratio of amine groups to acid groups, e.g. the appropriate stoichiometric ratio of diamine and diacid during the synthesis of the polyamide.

As discussed above, the polyamide composition of the present disclosure may include a second polyamide component. In some embodiments, the second polyamide component may include a multifunctional polyamidoamine or a hotmelt dimer acid based polyamide such as those described in U.S. Pat. No. 3,377,303. In some embodiments, suitable multifunctional polyamidoamines include those described in U.S. Pat. No. 2,705,222, which is herein incorporated by reference in its entirety. Commercially available multifunctional polyamidoamines are available under the trade designation VERSAMID 150 and VERSAMID 115, both from Gabriel Chemicals, Akron, Ohio, for example. Commercially available hotmelt polyamides are available under the trade designation UNI-REZ 2651 and UNI-REZ 2671, both from Arizona Chemical, Jacksonville, Florida, for example. In some embodiments, the polyamides of the second polyamide component may be liquid at room temperature (e.g., a viscous liquid of 500-50,000 cP). It is to be appreciated that polyamides of the second polyamide component, alone, were discovered to be inadequate in enhancing the elongation at break of the curable compositions, while maintaining good adhesion to metallic substrates. Rather, it was discovered that polyamides having tertiary amides in the backbone provided these desired attributes.

In some embodiments, the polyamide compositions of the present disclosure may include the first polyamide component in an amount of between 50 wt. % and 100 wt. %, 75 wt. % and 100 wt. %, 95 wt. % and 100 wt. %, 50 wt. % and 95 wt. %, or 75 wt. % and 95 wt. %, based on the total weight of polyamide in the polyamide composition. In some embodiments, the polyamide compositions of the present disclosure may include the first polyamide component in an amount of at least 50 wt. % at least 70 wt. %, at least 90 wt. %, or at least 95 wt. %, based on the total weight of polyamide in the polyamide composition. The polyamide compositions of the present disclosure may include the second polyamide component in an amount of between 0.01 wt. % and 50 wt. %, 0.1 wt. % and 25 wt. %, 0.5 wt. % and 10 wt. %, or 1 and 5 wt.%, based on the total weight of polyamide in the polyamide composition.

In some embodiments, the polyamide compositions of the present disclosure may include polyamides in an amount of between 5 wt. % and 40 wt. %, 10 wt. % and 30 wt. %, 15 wt. % and 30 wt. %, or 20 wt. % and 30 wt. %, (or may be even higher (up to 95%, 99%, or 100%) for curable compositions that do not include fillers) based on the total weight of the polyamide composition.

In some embodiments, the epoxy composition may be present in the curable compositions of the present disclosure in an amount of between 5 wt. % and 90 wt. %, 10 wt. % and 85 wt. %, 10 wt. % and 75 wt. %, 15 wt. % and 60 wt. %, or 15 wt. % and 50 wt. %, based on the total weight of the curable composition. In some embodiments, the epoxy composition may be present in the curable compositions of the present disclosure in an amount of at least 5 wt. %, at least 10 wt. %, at least 20 wt. %, at least 30 wt. %, at least 40 wt. %, or at least 50 wt. %, based on the total weight of the curable composition. In some embodiments, the polyamide composition may be present in the curable compositions of the present disclosure in an amount of between 5 wt. % and 90 wt. %, 10 wt. % and 85 wt. %, 10 wt. % and 75 wt. %, 15 wt. % and 60 wt. %, or 15 wt. % and 50 wt. %, based on the total weight of the curable composition. In some embodiments, the polyamide composition may be present in the curable compositions of the present disclosure in an amount of at least 5 wt. %, at least 10 wt. %, at least 20 wt. %, at least 30 wt. %, at least 40 wt. %, or at least 50 wt. %, based on the total weight of the curable composition.

In some embodiments, the epoxy and polyamide compositions may be present in the curable compositions based on stoichiometric ratios of the functional groups of the respective components. For example, the relative amounts of the epoxy and polyamide compositions may be based on the stoichiometric ratio (1:1) of the amine hydrogen (N—H) groups of the polyamide composition and the oxirane groups of the epoxy composition. Employing such relative amounts may be advantageous in that it can reduce the amount of residual unreacted polyamide or epoxy in the cured composition, which residual components can migrate or provide environmental or health challenges.

In some embodiments, the curable compositions of the present disclosure may be provided (e.g., packaged) as a two-part composition, in which a first part includes the above-described epoxy composition and a second part includes the above described polyamide composition. The other components of the curable adhesive composition (e.g., inorganic fillers, tougheners, dispersants, catalysts, antioxidants, and the like), described in further detail below, can be included in one or both of the first and second parts. The present disclosure further provides a dispenser comprising a first chamber and a second chamber. The first chamber comprises the first part, and the second chamber comprises the second part.

In some embodiments, the curable compositions may include one or more inorganic fillers (e.g. thermally conductive inorganic fillers). Generally, the selection and loading levels of the inorganic fillers may be used to control the thermal conductivity of the curable composition. In some embodiments, inorganic filler loadings may be at least 20 vol. %, at least 30 vol. %, at least 40 vol. %, at least 50 vol. %, at least 60 vol. %, at least 70 vol. %, at least 80 vol. %, based on the total volume of any or all of the epoxy composition, the polyamide composition, or the curable composition. In some embodiments, inorganic filler loadings may be between 20 and 90 vol. %, between 30 and 80 vol. %, between 50 and 70 vol. %, or between 60 and 65 vol. %, based on the total volume of any or all of the epoxy composition, the polyamide composition, or the curable composition. It should be noted that for some applications (e.g., applications not requiring thermal conductivity), the curable compositions may not include inorganic fillers or include inorganic fillers in a very small amount.

Generally, any known thermally conductive fillers may be used, although electrically insulating fillers may be preferred where breakthrough voltage is a concern. Suitable electrically insulating, thermally conductive fillers include ceramics such as oxides, hydroxides, oxyhydroxides, silicates, borides, carbides, and nitrides. Suitable ceramic fillers include, e.g., silicon oxide, aluminum oxide, aluminum trihydroxide (ATH), boron nitride, silicon carbide, and beryllium oxide. In some embodiments, the thermally conductive filler includes ATH. It is to be appreciated that while ATH is not generally used in the polyurethane based compositions commonly employed in thermal management materials because of its reactivity with isocyanate species and the resultant formulation difficulties, the curable compositions of the present disclosure are able to incorporate such inorganic fillers without drawback. Other thermally conducting fillers include carbon based materials such as graphite and metals such as aluminum and copper.

Thermally conductive filler particles are available in numerous shapes, e.g. spheres, irregular, platelike, & acicular. Through-plane thermal conductivity may be important in certain applications. Therefore, in some embodiments, generally symmetrical (e.g., spherical or semi-spherical) fillers may be employed. To facilitate dispersion and increase filler loading, in some embodiments, the thermally conductive fillers may be surface-treated or coated. Generally, any known surface treatments and coatings may be suitable, including those based on silane, titanate, zirconate, aluminate, and organic acid chemistries. For powder handling purposes, many fillers are available as polycrystalline agglomerates or aggregates with or without binder. To facilitate high thermal conductivity formulations, some embodiments may include mixtures of particles and agglomerates in various size and mixtures.

In some embodiments, the curable compositions of the present disclosure may further include one or more multifunctional amines. In some embodiments, the functional amino groups may be primary amino, secondary amino, or tertiary amino. In some embodiments, the amino functional compounds may include from 2-20, 3-18, or 4-15 carbon atoms. In some embodiments, the amino functional compounds may include aliphatic, cycloaliphatic, or aromatic diamines. In illustrative embodiments, the diamines may include di-primary amines with an average molecular weight of 30 to 600 or 60 to 400. In some embodiments, suitable diamines may include alkylene polyamines such as 1,3-diaminopropane, 1,6-hexamethylene diamine, ethylenediamine, 1,10-decamethylene diamine, diethylene triamine, triethylenetriamine, tetraethylenepentamine, 2-methylpentamethylenediamine; cycloaliphatic diamines such as 1,4-, 1,3-, and 1,2-diaminocyclohexane, 4,4′-, 2,4′-, 2,2′-diamino dicyclohexylmethane, 3-aminomethyl-3,5,5-trimethylcyclohexylamine, 1,4-, and 1,3- diaminomethylcyclohexane, 3(4),8(9)-Bis(aminomethyl)-tricyclo[5.2.1.0(2.6)]decane, bicyclo12.2.1]heptanebis(methylamine); aromatic diamines such as meta- xylene diamine; and other amine curing agents, such as ethanolamine, methylimino-bis (propyl) amine, aminoethyl- piperazine, polyoxyethylene diamines, or polyoxypropylene diamines or triamines. In some embodiments, in addition to the diamines, the cured compositions may include one or more triamines. In some embodiments, the multifunctional amines may be present in the curable compositions of the present disclosure in an amount of between 0.2 wt. % and 30 wt. %, 0.5 wt. % and 20 wt. %, 1 wt. % and 15 wt. %, 1.5 wt. % and 10 wt. %, or 2 wt. % and 5 wt. %, based on the total weight of the curable composition. In some embodiments, the multifunctional amines may be present in the curable compositions of the present disclosure in an amount of at least 0.2 wt. %, at least 0.5 wt. %, at least 1 wt. %, at least 1.5 wt. %, at least 2 wt. %, or at least 10 wt. %, based on the total weight of the curable composition. Generally, the multifunctional amines may serve to reduce viscosity, accelerate cure time, or dissolve catalysts present in the curable composition

In some embodiments, in addition to the polyamides of the present disclosure (which may be considered tougheners), the curable compositions of the present disclosure may also include one or more epoxy toughening agents. Such toughening agents may be useful, for example, for improving the properties (e.g., peel strength) of some cured epoxies, for example, so that they do not undergo brittle failure in a fracture. The toughening agent (e.g., an elastomeric resin or elastomeric filler) may or may not be covalently bonded to the curable epoxy and ultimately the crosslinked network. In some embodiments, the toughening agent may include an epoxy-terminated compound, which can be incorporated into the polymer backbone. Examples of useful toughening agents, which may also be referred to as elastomeric modifiers, include polymeric compounds having both a rubbery phase and a thermoplastic phase such as graft copolymers having a polymerized diene rubbery core and a polyacrylate or polymethacrylate shell; graft copolymers having a rubbery core with a polyacrylate or polymethacrylate shell; elastomeric particles polymerized in situ in the epoxide from free-radical polymerizable monomers and a copolymeric stabilizer; elastomer molecules such as polyurethanes and thermoplastic elastomers; separate elastomer precursor molecules; combination molecules that include epoxy-resin segments and elastomeric segments; and, mixtures of such separate and combination molecules. The combination molecules may be prepared by reacting epoxy resin materials with elastomeric segments; the reaction leaving reactive functional groups, such as unreacted epoxy groups, on the reaction product. The use of tougheners in epoxy resins is described in the Advances in Chemistry Series No. 208 entitled “Rubbery-Modified Thermoset Resins”, edited by C. K. Riew and J. K. Gillham, American Chemical Society, Washington, 1984. The amount of toughening agent to be used depends in part upon the final physical characteristics of the cured resin desired.

In some embodiments, the toughening agent in the curable compositions of the present disclosure may include graft copolymers having a polymerized diene rubbery backbone or core to which is grafted a shell of an acrylic acid ester or methacrylic acid ester, monovinyl aromatic hydrocarbon, or a mixture thereof, such as those disclosed in U.S. Pat. No. 3,496,250 (Czerwinski). Rubbery backbones can comprise polymerized butadiene or a polymerized mixture of butadiene and styrene. Shells comprising polymerized methacrylic acid esters can be lower alkyl (C₁₋₄) methacrylates. Monovinyl aromatic hydrocarbons can be styrene, alpha-me thylstyrene, vinyltoluene, vinylxylene, ethylvinylbenzene, isopropylstyrene, chlorostyrene, dichlorostyrene, and ethylchlorostyrene.

Further examples of useful toughening agents are acrylate core-shell graft copolymers wherein the core or backbone is a polyacrylate polymer having a glass transition temperature (T_{g}) below about 0° C., such as poly(butyl acrylate) or poly(isooctyl acrylate) to which is grafted a polymethacrylate polymer shell having a T_{g} about 25° C. such as poly(methyl methacrylate). For acrylic core/shell materials “core” will be understood to be acrylic polymer having T_{g}<0° C. and “shell” will be understood to be an acrylic polymer having T_{g}>25° C. Some core/shell toughening agents (e.g., including acrylic core/shell materials and methacrylate-butadiene-styrene (MBS) copolymers wherein the core is crosslinked styrene/butadiene rubber and the shell is polymethylacrylate) are commercially available, for example, from Dow Chemical Company under the trade designation “PARALOID”.

Another useful core-shell rubber is described in U.S. Pat. Appl. Publ. No. 2007/0027233 (Yamaguchi et al.). Core-shell rubber particles as described in this document include a cross-linked rubber core, in most cases being a cross-linked copolymer of butadiene, and a shell which is preferably a copolymer of styrene, methyl methacrylate, glycidyl methacrylate and optionally acrylonitrile. The core-shell rubber can be dispersed in a polymer or an epoxy resin. Examples of useful core-shell rubbers include those sold by Kaneka Corporation under the designation Kaneka KANE ACE, including the Kaneka KANE ACE 15 and 120 series of products, including Kaneka “KANE ACE MX 153”, Kaneka “KANE ACE MX 154”, Kaneka “KANE ACE MX 156”, Kaneka “KANE ACE MX 257” and Kaneka “KANE ACE MX 120” core-shell rubber dispersions, and mixtures thereof. The products contain the core-shell rubber (CSR) particles pre-dispersed in an epoxy resin, at various concentrations. For example, “KANE ACE MX 153” core-shell rubber dispersion comprises 33% CSR, “KANE ACE MX 154” core-shell rubber dispersion comprises 40% CSR, and “KANE ACE MX 156” core-shell rubber dispersions comprise 25% CSR.

Other useful toughening agents include carboxyl- and amine-terminated acrylonitrile/butadiene elastomers such as those obtained from Emerald Performance Materials, Akron, Ohio, under the trade designation “HYPRO” (e.g., CTBN and ATBN grades); carboxyl- and amine-terminated butadiene polymers such as those obtained from Emerald Performance Materials under the trade designation “HYPRO” (e.g., CTB grade); amine-functional polyethers such as any of those described above; and amine-functional polyurethanes such as those described in U.S. Pat. Appl. No. 2013/0037213 (Frick et al.). In some embodiments, the toughening agent may include an acrylic core/shell polymer; a styrene-butadiene/methacrylate core/shell polymer; a polyether polymer; a carboxyl- or amino-terminated acrylonitrile/butadiene; a carboxylated butadiene, a polyurethane, or a combination thereof.

In some embodiments, toughening agents (excluding polyamides) may be present in the curable composition (or the epoxy composition) in an amount between 0.1 and 10 wt. %, 0.1 and 5 wt. %, 0.5 and 5 wt. %, 1 and 5 wt. %, or 1 and 3 wt. %, based on the total weight of any or all of the epoxy composition or the curable composition.

In some embodiments, the curable compositions according to the present disclosure may include one or more dispersants. Generally, the dispersants may act to stabilize the inorganic filler particles in the composition - without dispersant, the particles may aggregate, thus adversely affecting the benefit of the particles in the composition. Suitable dispersants may depend on the specific identity and surface chemistry of filler. In some embodiments, suitable dispersants according to the present disclosure may include at least a binding group and a compatibilizing segment. The binding group may be ionically bonded to the particle surface. Examples of binding groups for alumina particles include phosphoric acid, phosphonic acid, sulfonic acid, carboxylic acid, and amine. The compatibilizing segment may be selected to be miscible with the curable matrix. For epoxy resin and amide matrices, useful compatibilizing agents may include polyalkylene oxides, e.g., polypropylene oxide, polyethylene oxide, as well as polycaprolactones, and combinations thereof. Commercially available examples include BYK W-9010 (BYK Additives and Instruments), BYK W-9012 (BYK Additives and Instruments), Disberbyk 180 (BYK Additives and Instruments), and Solplus D510 (Lubrizol Corporation),In some embodiments, the dispersants may be present in the curable composition (or the epoxy composition or the amide composition) in an amount between 0.1 and 10 wt. %, 0.1 and 5 wt. %, 0.5 and 3 wt. %, or 0.5 and 2 wt. %, based on the total weight of any or all of the epoxy composition, the polyamide composition, or the curable composition.

In some embodiments, the dispersant may be pre-mixed with the inorganic filler prior to incorporating into any or all of the epoxy, polyamide, or curable compositions. Such pre-mixing may facilitate the filled systems behaving like Newtonian fluids or enable shear-thinning effects behavior.

In some embodiments, the curable compositions according to the present disclosure may further include one or more catalysts. Generally, the catalysts may be present in the compositions pre-cure to accelerate the cure rate of the curable composition, and then remain in the composition post-cure. In some embodiments, the catalyst may include a Lewis acid. Such Lewis acids may include metal salts, triorganoborates including trialkylborates (including those represented by the formula B(OR)3, wherein each R is independently alkyl) and the like, and combinations thereof. Useful metal salts include those that comprise at least one metal cation that acts as a Lewis acid. Preferred metal salts include metal salts of organic acids (metal carboxylates (including both aliphatic and aromatic carboxylates), sulfonic acid (like trifluoromethanesulfonic acid), mineral acid (like nitric acid) and combinations thereof. Useful metal cations include those that have at least one vacant orbital. Suitable metals include calcium, zinc, iron, copper, bismuth, aluminum, magnesium, or combinations thereof; calcium, zinc, bismuth, aluminum, magnesium, or combinations thereof; or calcium, zinc, bismuth, or combinations thereof; or calcium). In some embodiment the catalyst may include calcium triflate or calcium nitrate. Alternatively, or additionally, in some embodiments, the catalysts may include phosphoric acid; or a combination of N-(3-aminopropyl) piperazine and salicylic acid that is synergistic for accelerating the cure of polyglycidyl ether of a polyhydric phenol cured with a polyoxyalkylenepolyamine, which is discussed in U.S. Pat. No. 3,639,928, which is herein incorporated by reference in its entirety. In some embodiments, the catalysts may be present in the curable composition (or the epoxy composition or the amide composition) in an amount between 100 and 10,000 ppm; or 200 and 5,000 ppm, based on the total weight of any or all of the epoxy composition, the polyamide composition, or the curable composition.

In addition to the above discussed additives, further additives can be included in one or both of the first and second parts. For example, any or all of antioxidants/stabilizers, colorants, abrasive granules, thermal degradation stabilizers, light stabilizers, conductive particles, tackifiers, flow agents, bodying agents, flatting agents, inert fillers, binders, blowing agents, fungicides, bactericides, surfactants, plasticizers, and other additives known to those skilled in the art. These additives, if present, are added in an amount effective for their intended purpose.

In some embodiments, upon curing, the curable compositions of the present disclosure may exhibit thermal, mechanical, and rheological properties that render the compositions particularly useful as thermally conductive gap fillers. For example, it is believed that that curable compositions of the present disclosure provide an optimal blend of tensile strength, elongation at break, and overlap shear strength for certain EV battery assembly applications.

In some embodiments, the cured compositions may have an elongation at break that ranges from 0.1 to 200%, 0.5 to 175%, 1 to 160%, or 5 to 160%, with the pulling rate between 0.8 and 1.5 mm/min for fully cured systems (for purposes of the present application, elongation at break values are as measured in accordance with ASTM D638-03, “Standard Test Method for Tensile Properties of Plastics.”); or at least 5.5%, at least 6%, at least 7%, at least 10%, at least 50%, at least 100%, or at least 150%, with the pulling rate between 0.8 and 1.5 mm/min for fully cured systems.

In some embodiments, the cured compositions may have an overlap shear strength on a bare aluminum substrate ranging from 1-30 N/mm², 1-25 N/mm², 4-20 N/mm², 6-20 N/mm², 2 - 16 N/mm², or 3 - 8 N/mm², for fully cured systems (for purposes of the present application, overlap sheer strength values are as measured on untreated aluminum substrates (i.e., aluminum substrates having no surface treatments or coatings other than native oxide layers) in accordance with EN 1465 Adhesives—Determination of tensile lap-shear strength of bonded assemblies).

In some embodiments, the cured compositions may have a tensile strength ranging from 0.5-16 N/mm², 1-10 N/mm², or 2-8 N/mm², with the pulling rate between 0.8 and 1.5 mm/min for fully cured systems (for purposes of the present application, tensile strength values are as measured in accordance with EN ISO 527-2 Tensile Test).

In some embodiments, the compositions may have a cure rate may in the range of 1 to 240 hours, 1 to 72 hours, or 1 to 24 hours for complete curing at room temperature or 10 min to 6 hours, 10 minutes to 3 hours, or 30 minutes to 60 minutes for complete curing at 100° C.

In some embodiments, upon curing, the curable compositions of the present disclosure may have a thermal conductivity ranging from 1.0 to 5 W/(m*K), 1.0 to 2 W/(m*K), or 1.4 to 1.6 W/(m*k) (for purposes of the present application, thermal conductivity values are as determined by, first, measuring diffusivity according to ASTM E1461-13, “Standard Test Method for Thermal Diffusivity by the Flash Method” and, then, calculating thermal conductivity from the measured thermal diffusivity, heat capacity, and density measurements according the formula: k=α·cp·ρ, where k is the thermal conductivity in W/(m K), α is the thermal diffusivity in mm²/s, cp is the specific heat capacity in J/K-g, and ρ is the density in g/cm³. The sample thermal diffusivity can be measured using a Netzsch LFA 467 “HYPERFLASH” directly and relative to standard, respectively, according to ASTM E1461-13. Sample density can be measured using geometric methods, while the specific heat capacity can measured using Differential Scanning calorimetry.)

In some embodiments, within 10 minutes of mixing of the epoxy composition and the amide composition, the viscosity of curable/partially cured composition measured at room temperature may range from 100 to 50000 poise, and at 60° C. may range from 100 to 50000 poise. Further regarding viscosity, the viscosity of the epoxy composition (prior to mixing) measured at room temperature may range from 100 to 100000 poise, and at 60° C. may range from 10 to 10000 poise; and the viscosity of the amide composition (prior to mixing) measured at room temperature may range from 100 to 100000 poise, and at 60° C. may range from 10 to 10000 poise (for purposes of the present application, viscosity values are as measured using a 40 mm parallel-plate geometry at 1% strain on a ARES Rheometer (TA Instruments, Wood Dale, Ill., US) equipped with a forced convection oven accessory, at angular frequencies ranging from 10-500 rad/s.)

The present disclosure is further directed to methods of making the above-described curable compositions, and certain of the components of the curable compositions. For example, in some embodiments, the above-described first polyamide component may be prepared by reacting one or more of the above-described diacids with one or more of the above-described diamines. In some embodiments, the reaction may take place at a temperature ranging from 50 to 300° C., 75 to 250° C., or 100 to 225° C., In some embodiments, the reaction may take place at atmospheric pressure (760 torr) or at a pressure of below 300 torr, below 100 torr, below 50 torr, or below 30 torr. The reaction end point may be determined by the lack of evolution of the water by-product. The reaction may also be conducted using heterogenous aqueous azeotropes such as toluene, xylene as solvents to remove the water by-product. In such a case, it may be advantageous to distill the azeotropic solvent from the product mixture once the reaction no longer produces water. Such distillations may be carried out at atmospheric pressure or under vacuum as noted above. It is also known to those skilled in the art that the polyamide may be formed by the reaction of the corresponding acid chlorides of the carboxylic acids discussed above with diamines discussed above. In such cases, the reaction may be carried out in non-reactive anhydrous solvents such as toluene, xylene, tetrahydrofuran, triethylamine, at temperatures below 50 C. In such cases, it may be advantageous to distill of the solvent at the end of the reaction. It may sometimes be desirable to include catalysts, defoamers, or antioxidants. Phosphoric acid may be used as a catalyst at 5-500 ppm, based on the total reactant mass. Silicone defoamers may be employed such as those sold by Dow-Corning (Midland, Mich., US) at 1-100 ppm. It may also be advantageous to use antioxidants such as octylated diphenylamine or phenolic antioxidants such as those sold by BASF (Ludwigshafen, Germany) under the Irganox tradename (e.g. Irganox 1010 or Irganox 1035).

In some embodiments, the curable compositions of the present disclosure may be prepared by, first, mixing the components of the epoxy composition (including any additives) and, separately, mixing the components of the amide composition (including any additives). The components of both the epoxy and amide composition may be mixed using any conventional mixing technique, including by use of a speed mixer. In embodiments in which dispersants are employed, the dispersant may be pre-mixed with the inorganic filler prior to incorporating into the composition. Next, the epoxy composition and the amide composition may be mixed using any conventional mixing technique to form the curable composition.

In some embodiments, the curable compositions of the present disclosure may be capable of curing without the use of catalyst or other cure agents. Generally, the curable compositions may cure at typical application conditions, e.g., at room temperature without the need for elevated temperatures or actinic radiation (e.g., ultraviolet light). In some embodiments, the first curable compositions cure at no greater than room temperature.

In some embodiments, the curable compositions of the present disclosure may be provided as a two-part composition. Generally, the two components of a two-part composition may be mixed prior to being applied to the substrates to be bonded. After mixing, the two-part composition may reach a desired handling strength, and ultimately achieve a desired final strength. Applying the curable composition can be carried out, for example, by dispensing the curable composition from a dispenser comprising a first chamber, a second chamber, and a mixing tip, wherein the first chamber comprises the first part, wherein the second chamber comprises the second part, and wherein the first and second chambers are coupled to the mixing tip to allow the first part and the second part to flow through the mixing tip.

The curable compositions of the present disclosure may be useful for coatings, shaped articles, adhesives (including structural and semi-structural adhesives), magnetic media, filled or reinforced composites, caulking and sealing compounds, casting and molding compounds, potting and encapsulating compounds, impregnating and coating compounds, conductive adhesives for electronics, protective coatings for electronics, as primers or adhesion-promoting layers, and other applications that are known to those skilled in the art. In some embodiments, the present disclosure provides an article comprising a substrate, having a cured coating of the curable composition thereon.

In some embodiments, the curable composition may function as a structural adhesive, i.e. the curable composition is capable of bonding a first substrate to a second substrate, after curing. Generally, the bond strength (e.g. peel strength, overlap shear strength, or impact strength) of a structural adhesive continues to build well after the initial cure time. In some embodiments, the present disclosure provides an article comprising a first substrate, a second substrate and a cured composition disposed between and adhering the first substrate to the second substrate, wherein the cured composition is the reaction product of the curable composition according to any one of the curable compositions of the present disclosure. In some embodiments, the first and/or second substrate may be at least one of a metal, a ceramic and a polymer, e.g. a thermoplastic.

The curable compositions may be coated onto substrates at useful thicknesses ranging from 5 microns to 10000 microns, 25 micrometers to 10000 micrometers, 100 micrometers to 5000 micrometers, or 250 micrometers to 1000 micrometers. Useful substrates can be of any nature and composition, and can be inorganic or organic. Representative examples of useful substrates include ceramics, siliceous substrates including glass, metal (e.g., aluminum or steel), natural and man-made stone, woven and nonwoven articles, polymeric materials, including thermoplastic and thermosets, (such as polymethyl (meth)acrylate, polycarbonate, polystyrene, styrene copolymers, such as styrene acrylonitrile copolymers, polyesters, polyethylene terephthalate), silicones, paints (such as those based on acrylic resins), powder coatings (such as polyurethane or hybrid powder coatings), and wood; and composites of the foregoing materials.

In another aspect, the present disclosure provides a coated article comprising a metal substrate comprising a coating of the uncured, partially cured or fully cured curable composition on at least one surface thereof. If the substrate has two major surfaces, the coating can be coated on one or both major surfaces of the metal substrate and can comprise additional layers, such as bonding, tying, protective, and topcoat layers. The metal substrate can be, for example, at least one of the inner and outer surfaces of a pipe, vessel, conduit, rod, profile shaped article, sheet or tube.

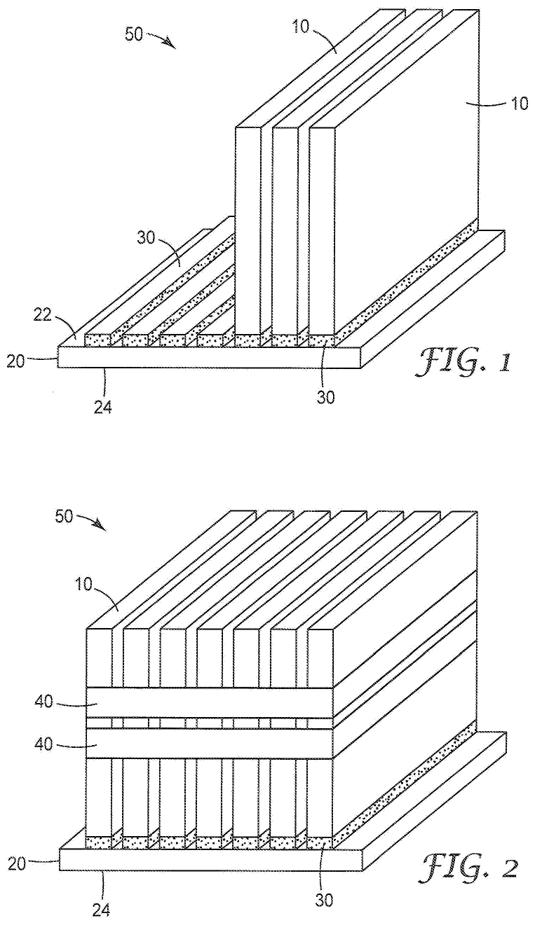

In some embodiments, the present disclosure is further directed to a battery module that includes the uncured, partially cured or fully cured curable compositions of the present disclosure. Components of a representative battery module during assembly are shown in FIG. 1, and an assembled battery module is shown in FIG. 2. Battery module 50 may be formed by positioning a plurality of battery cells 10 on first base plate 20.

Generally, any known battery cell may be used including, e.g., hard case prismatic cells or pouch cells. The number, dimensions, and positions of the cells associated with a particular battery module may be adjusted to meet specific design and performance requirements. The constructions and designs of the base plate are well-known, and any base plate (typically metal base plates made of aluminum or steel) suitable for the intended application may be used.

Battery cells 10 may be connected to first base plate 20 through first layer 30 of a first curable composition according to any of the embodiments of the present disclosure. First layer 30 of the curable composition may provide first level thermal management where the battery cells are assembled in a battery module. As a voltage difference (e.g., a voltage difference of up to 2.3 Volts) is possible between the battery cells and the first base plate, breakthrough voltage may be an important safety feature for this layer. Therefore, in some embodiments, electrically insulating fillers like ceramics (typically alumina and boron nitride) may be preferred for use in the curable compositions.

In some embodiments, layer 30 may comprise a discrete pattern of the first curable composition applied to first surface 22 of first base plate 20, as shown in FIG. 1. For example, a pattern of the material to the desired lay-out of the battery cells may be applied, e.g., robotically applied, to the surface of the base plate. In some embodiments, the first layer may be formed as a coating of the first curable composition covering all or substantially all of the first surface of the first base plate. In alternative embodiments, the first layer may be formed by applying the curable composition directly to the battery cells and then mounting them to the first surface of the first base plate.

In some embodiments, the curable composition may need to accommodate dimensional variations of up to 2 mm, up to 4 mm, or even more. Therefore, in some embodiments, the first layer of the first curable composition may be at least 0.05 mm thick, e.g., at least 0.1 mm, or even at least 0.5 mm thick. Higher breakthrough voltages may require thicker layers depending on the electrical properties of the material, e.g., in some embodiments, at least 1, at least 2, or even at least 3 mm thick. Generally, to maximize heat conduction through the curable composition and to minimize cost, the curable composition layer should be as thin as possible, while still ensure good contact with the heat sink. Therefore, in some embodiments, the first layer is no greater than 5 mm thick, e.g., no greater than 4 mm thick, or even no greater than 2 mm thick.

As the first curable composition cures, the battery cells are held more firmly in-place. When curing is complete, the battery cells are finally fixed in their desired position, as illustrated in FIG. 2. Additional elements, such as bands 40 may be used to secure the cells for transport and further handling.

Generally, it is desirable for the curable composition to cure at typical application conditions, e.g., without the need for elevated temperatures or actinic radiation (e.g., ultraviolet light). In some embodiments, the first curable composition cures at room temperature, or no greater than 30° C., e.g., no greater than 25° C., or even no greater than 20° C.

In some embodiments, the time to cure is no greater than 60 minutes, e.g., no greater than 40 minutes, or even no greater than 20 minutes. Although very rapid cure (e.g., less than 5 minutes or even less than 1 minute) may be suitable for some applications, in some embodiments, an open time of at least 5 minutes, e.g., at least 10 minutes, or even at least 15 minutes may be desirable to allow time for positioning and repositioning of the battery cells. Generally, it is desirable to achieve the desired cure times without the use of expensive catalysts such as platinum.

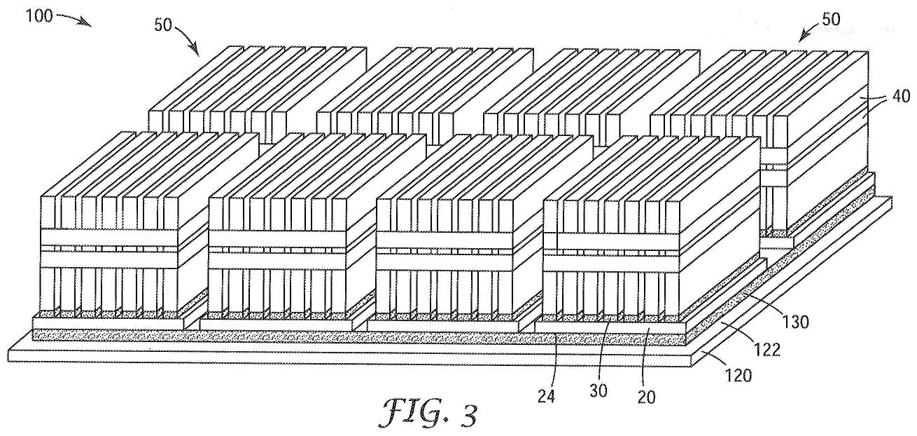

As shown in FIG. 3, a plurality of battery modules 50, such as those illustrated and described with respect to FIGS. 1 and 2, are assembled to form battery subunit 100. The number, dimensions, and positions of the modules associated with a particular battery subunit may be adjusted to meet specific design and performance requirements. The constructions and designs of the second base plate are well-known, and any base plate (typically metal base plates) suitable for the intended application may be used.

Individual battery modules 50 may be positioned on and connected to second base plate 120 through second layer 130 of a curable composition according to any of the embodiments of the present disclosure.

Second layer 130 of a second curable composition may be positioned between second surface 24 of first base plate 20 (see FIGS. 1 and 2) and first surface 122 of second base plate 120. The second curable composition may provide second level thermal management where the battery modules are assembled into battery subunits. At this level, breakthrough voltage may not be a requirement. Therefore, in some embodiments, electrically conductive fillers such as graphite and metallic fillers may be used or alone or in combinations with electrically insulating fillers like ceramics.

In some embodiments, the second layer 130 may be formed as coating of the second curable composition covering all or substantially all of first surface 122 of second base plate 120, as shown in FIG. 3. In some embodiments, the second layer may comprise a discrete pattern of the second curable composition applied to the surface of the second base plate. For example, a pattern of the material corresponding to the desired lay-out of the battery modules may be applied, e.g., robotically applied, to the surface of the second base plate. In alternative embodiments, the second layer may be formed by applying the second curable composition directly to second surface 24 of first base plate 20 (see FIGS. 1 and 2) and then mounting the modules to first surface 122 of second base plate 120.

The assembled battery subunits may be combined to form further structures. For example, as is known, battery modules may be combined with other elements such as battery control units to form a battery system, e.g., battery systems used in electric vehicles. In some embodiments, additional layers of curable compositions according to the present disclosure may be used in the assembly of such battery systems. For example, in some embodiments, thermally conductive gap filler according to the present disclosure may be used to mount and help cool the battery control unit.

### Listing of Embodiments

1. A curable composition comprising:

a polyamide composition comprising a polyamide, the polyamide comprising a tertiary amide in the backbone thereof and being amine terminated; and

an epoxy composition comprising an epoxy resin.
2. The curable composition of embodiment 1, wherein tertiary amides are present in the polyamide in an amount of at least 50 mol %, based on the total amide content present in the polyamide backbone.
3. The curable composition according to any one of the previous embodiments, further comprising
an inorganic filler present in an amount of at least 20 volume%, based on the total volume of the curable composition.
4. The curable composition according to any one of the previous embodiments, the polyamide composition further comprising a second polyamide, wherein the second polyamide comprises a multifunctional polyamidoamine.
5. A curable composition comprising:

a polyamide composition comprising
a first polyamide component comprising the reaction product of
   (i) a diacid; and
   (ii) a diamine, wherein the diamine comprises a secondary diamine or a secondary/primary hybrid diamine;
   wherein the first polyamide component comprises a tertiary amide in the backbone thereof and is amine terminated; and
a second polyamide component; and

an epoxy composition comprising an epoxy resin.
6. The curable composition according to embodiment 5, wherein the mole ratio of diamine to diacid in the first polyamide component is between 1.2 and 3.
7. The curable composition according to any one of embodiments 5 to 6, wherein

the diamine has a formula R1-NH-R2-NH—R1;

the R2 group is an alkylene, branched alkylene, cycloalkylene, substituted or unsubstituted arylene, heteroalkylene, or heterocycloalkylene; and

(i) each R1 group, independently, is a linear or branched alkyl, cycloalkyl, aryl, heteroalkyl, heteroaryl, or hydrogen atom, with the proviso that both Rls are not hydrogen atoms, or

(ii) the R1 groups are alkylene or branched alkylene and form a heterocyclic compound.
8. The curable composition according to any one of embodiments 5 to 7, wherein the diamine comprises piperazine.
9. The curable composition according to any one of embodiments 5 to 8, wherein the second polyamide component comprises a multifunctional polyamidoamine.
10. The curable composition according to any one of embodiments 5 to 9, wherein the first polyamide component is present in the polyamide composition in an amount of at least 50 wt. %, based on the total weight of polyamide in the polyamide composition.
11. The curable composition according to any one of embodiments 5 to 10, wherein the diacid comprises at least 80 mol % long chain diacid, based on the total moles of the diacid.
12. The curable composition according to any one of embodiments 5 to 11, wherein the diacid comprises a dicarboxylic dimer acid.
13. The curable composition according to any one of the previous embodiments, further comprising an inorganic filler present in an amount of at least 20 volume %, based on the total volume of the curable composition.
14. The curable composition according to any one of the previous embodiments, wherein epoxy resin is present in the epoxy composition in an amount of at least 15 wt. %, based on the total weight of the epoxy composition.
15. The curable composition according to any one of the previous embodiments, wherein polyamides are present in the polyamide composition in an amount of at least 15 wt. %, based on the total weight of the polyamide composition.
16. The curable composition according to any one of the previous embodiments, wherein the curable composition provides, upon curing, (i) an elongation at break of greater than 5.5%, and (ii) an overlap shear strength, on untreated aluminum, of 6-20 N/mm².
17. A curable composition comprising:

a polyamide;

an epoxy resin; and

an inorganic filler present in the curable composition in an amount of at least 20 volume %, based on the total volume of the curable composition;

wherein the curable composition provides, upon curing, (i) an elongation at break of greater than 5.5%, and (ii) an overlap shear strength of 5-20 N/mm².
18. The curable composition according to embodiment 17, wherein the curable composition provides, upon curing, a tensile strength of 0.5 to 16 N/mm2.
19. The curable composition according to embodiment 18, wherein the curable composition provides, upon curing, an elongation at break of greater than 6%.
20. The curable composition according to embodiment 19, wherein the curable composition provides, upon curing, an elongation at breakoff greater than 7%.
21. The curable composition of any one of embodiments 17-20, wherein the polyamide comprises a tertiary amide in the backbone thereof and is amine terminated.
22. The curable composition of any one of embodiments 3-4, 13-16, or 17-21, wherein the inorganic filler comprises ATH.
23. The curable composition according to any one of the previous embodiments, further comprising a dispersant comprising a binding group and a compatibilizing segment.
24. An article comprising a cured composition, wherein the cured composition is the reaction product of the curable composition according to any one of the previous embodiments.
25. The article of embodiment 24, wherein the cured composition has a thickness between from 5 microns to 10000 microns.
26. The article of any one of embodiments 24-25, further comprising a substrate having a surface, wherein the cured composition is disposed on the surface of the substrate.
27. The article of embodiment 26, wherein the substrate is a metal substrate.
28. An article comprising a first substrate, a second substrate and a cured composition disposed between and adhering the first substrate to the second substrate, wherein the cured composition is the reaction product of the curable composition according to any one of embodiments 1-23.
29. A battery module comprising a plurality of battery cells connected to a first base plate by a first layer of a curable composition according to any one of embodiments 1-23.
30. A method of making a battery module comprising: applying a first layer of a curable composition according to any one of embodiments 1-23 to a first surface of a first base plate, attaching a plurality of battery cells to the first layer to connect the battery cells to the first base plate, and curing the curable composition.

### EXAMPLES

Objects and advantages of this disclosure are further illustrated by the following comparative and illustrative examples. Unless otherwise noted, all parts, percentages, ratios, etc. in the examples and the rest of the specification are by weight, and all reagents used in the examples were obtained, or are available, from general chemical suppliers such as, for example, Sigma-Aldrich Corp., Saint Louis, Mo., US unless otherwise specified.

### Preparation Procedures

TABLE 1
Materials used

| | Product | | | Source |
|---|---|---|---|---|
| Material | Name | Purpose | Source | Location |
| Polyamide | Liquid | Crosslinker/ | Synthesis procedures | |
| 1 | Polyamide | Toughener | provided below | |
| Polyamide | Liquid | Crosslinker/ | Synthesis procedures | |
| 2 | Polyamide | Toughener | provided below | |
| Polyamide | VERSAMID | Crosslinker | Gabriel | Akron, |
| 3 | 150 | | Chemicals | OH, US |
| Polyamide | VERSAMID | Crosslinker | Gabriel | Akron, |
| 4 | 115 | | Chemicals | OH, US |
| Epoxy 1 | EPON 828 | Crosslinker | Hexion | Columbus, |
| | | | | OH, US |
| Epoxy 2 | 1,4- | Crosslinker | Sigma | St. Louis, |
| | Butanediol | | Aldrich | MO, US |
| | diglycidyl | | | |
| | ether | | | |
| Amine 1 | DYTEK A | Crosslinker | TCI | Portland, |
| | | | | OR, US |
| Amine 2 | PRIAMINE | Crosslinker | Croda | Delaware, |
| | 1074 | | | US |
| Toughener | HYPRO | Toughener | EMERALD | Akron, |
| 1 | ATBN | | Performance | OH, US |
| | 1300*42 | | chemicals | |
| Toughener | JEFFAMINE | Toughener | Huntsman | Woodlands, |
| 2 | THF-100 | | | TX, US |
| Toughener | PRIPOL | Toughener | Croda | New Castle, |
| 3 | 2033 | | | DE, US |
| Toughener | EM505-G20 | Core/Shell | LG Chem | Korea |
| 4 | | Rubber | | |
| | | Toughener | | |
| Filler 1 | Aluminum | Thermally | KC | Korea |
| | hydroxide | conductive | Industries | |
| | (ATH, D50 = | filler | | |
| | 17 μm) | | | |
| Filler 2 | TM1250 | Thermally | Huber | Edison, |
| | | conductive | | NJ, US |
| | | filler | | |
| Filler 3 | BAK-40 | Thermally | Bestry | Shanghai, |
| | Spherical | conductive | Performance | China |
| | Alumina | filler | Materials | |
| Accelerator | Calcium | Catalyst | Sigma | St. Louis, |
| 1 | triflate | | Aldrich | MO, US |
| Accelerator | DBU | Catalyst | Sigma | St. Louis, |
| 2 | | | Aldrich | MO, US |
| Dispersant | SOLPLUS | Dispersant | Lubrizol | Wickliffe, |
| 1 | D510 | | | OH, US |
| Dispersant | BYK-W9012 | Dispersant | BYK | Wesel, |
| 2 | | | Chemie | Germany |

The two-part polyamide/epoxy semi-structural adhesives with high thermal conductivity were formulated using the materials listed in Table 1. The polyamide component (Part A) comprised one or more polyamides as crosslinker, a toughening agent, a thermally conductive filler, a dispersant, and an optional chain extender. The epoxy component (Part B) was comprised of an aromatic epoxy and thermally conductive fillers. In some examples, Part B also contained a dispersant. Detailed formulations for Examples 1-8 and 12-19, and Comparative Examples CE9, CE10, and CE11 are listed in Tables 2 and 3.

A speed mixer (SPEEDMIXER DAC 150.1 FVZ-K, FlackTek, Inc., Landrum, S.C., US) was used to thoroughly mix the thermally conductive filler powders with resins for each part individually, using a speed of 3000 rpm for 3 min at room temperature. If a dispersant was used, pre-mixing of the dispersant with the thermally conductive filler (2000 rpm for 2 min) was performed before adding any other components. Part A and Part B were mixed based on stoichiometric ratios of the functional groups: amine hydrogen (N-H) groups for Part A and oxirane groups for Part B. Either hand or speed mixing was used for this purpose. The weight ratios of part A and part B for Examples 1 are listed in Tables 2 and 3.

TABLE 2
Composition of Examples

| | Ex. 1 | Ex. 2 | Ex. 3 | Ex. 4 | Ex. 5 | Ex. 6 | Ex. 7 | Ex. 8 | Ex. 18 | Ex. 19 |
|---|---|---|---|---|---|---|---|---|---|---|
| | wt % | wt % | wt % | wt % | wt % | wt % | wt % | wt % | wt % | wt % |
| Part A | | | | | | | | | | |
| Polyamide 1 | 90 | — | — | — | — | — | — | — | — | — |
| Polyamide 2 | — | — | — | — | — | — | — | | 20.3 | 20.8 |
| Polyamide 3 | 10 | — | 16 | 15.9 | 15.8 | 20 | — | 19.7 | — | — |
| Polyamide 4 | — | 24 | — | — | — | — | — | — | — | — |
| Filler 1 | — | — | — | — | 78.7 | 80 | — | 78.7 | — | — |
| Filler 2 | — | 70 | 80 | 79.7 | — | — | — | — | 54.1 | 48.7 |
| Filler 4 | — | — | — | — | — | — | — | — | 23.2 | 20.9 |
| Amine 1 | — | — | — | — | — | — | — | — | 0.5 | — |
| Amine 2 | — | — | — | — | — | — | — | — | — | 6.9 |
| Toughener 1 | — | 6 | 4 | 4.0 | 3.9 | — | — | — | — | — |
| Accelerator 1 | — | | | | | — | — | — | 0.4 | 1.4 |
| Dispersant 1 | — | — | — | 0.4 | 1.6 | — | — | 1.6 | 1.6 | 1.4 |
| Part B | | | | | | | | | | |
| Epoxy 1 | 100 | 30 | 20 | 19.9 | 19.7 | — | 20 | 19.7 | 19.9 | 8.3 |
| Epoxy 2 | — | — | — | — | — | — | — | — | — | 3.5 |
| Filler 1 | — | — | — | — | 78.7 | — | 80 | 78.7 | — | — |
| Filler 2 | — | 70 | 80 | 79.7 | — | — | — | — | 55.0 | 60.5 |
| Filler 3 | — | — | — | — | — | — | — | — | 23.6 | 25.9 |
| Dispersant 1 | — | — | — | 0.4 | 1.6 | — | — | 1.6 | 1.6 | 1.7 |
| Part A:Part B | 2.17 | 1.2 | 0.65 | 0.65 | 0.65 | — | — | 0.55 | 1.97 | 0.84 |
| (wt:wt) | | | | | | | | | | |
| total Vol % | 0 | 37.8 | 51.0 | 50.6 | 61.2 | — | — | 61.2 | 51.2 | 51.4 |
| filler | | | | | | | | | | |

TABLE 3
Composition of Examples and Comparative Examples
Utilizing Combinations of Polyamide Resins

| | CE9 | CE10 | CE 11 | Ex. 12 | Ex. 13 | Ex. 14 | Ex. 15 | Ex. 16 | Ex. 17 |
|---|---|---|---|---|---|---|---|---|---|
| | wt % | wt % | wt % | wt % | wt % | wt % | wt % | wt % | wt % |
| Part A | | | | | | | | | |
| Polyamide 1 | — | — | — | — | — | — | — | 17.7 | — |
| Polyamide 2 | — | — | — | 19.7 | 18.7 | 17.7 | 15.8 | — | 18.2 |
| Polyamide 3 | 17.7 | 15.8 | 17.7 | — | 1.0 | 2.0 | 3.9 | 2.0 | 2.0 |
| Filler 1 | 78.7 | 78.7 | 78.7 | 78.7 | 78.7 | 78.7 | 78.7 | 78.7 | 78.0 |
| Toughener 2 | — | — | 2.0 | — | — | — | — | — | — |
| Toughener 3 | 2.0 | 3.9 | — | — | — | — | — | — | — |
| Accelerator 2 | — | — | — | — | — | — | — | — | 0.16 |
| Dispersant 1 | 1.6 | 1.6 | 1.6 | 1.6 | 1.6 | 1.6 | 1.6 | 1.6 | 1.6 |
| Part B | | | | | | | | | |
| Epoxy 1 | 19.7 | 19.7 | 19.7 | 19.7 | 19.7 | 19.7 | 19.7 | 19.7 | 18.7 |
| Filler 1 | 78.7 | 78.7 | 78.7 | 78.7 | 78.7 | 78.7 | 78.7 | 78.7 | 79.7 |
| Filler 2 | — | — | — | — | — | — | — | — | — |
| Dispersant 1 | — | — | — | 1.6 | 1.6 | 1.6 | 1.6 | 1.6 | 1.6 |
| Dispersant 2 | 1.6 | 1.6 | 1.6 | — | — | — | — | — | — |
| Part A:Part B | 0.54 | 0.54 | 0.61 | 4 | 3.1 | 2.5 | 1.8 | 2.17 | 2.0 |
| (wt:wt) | | | | | | | | | |
| total Vol % | 61.2 | 61.2 | 61.2 | 61.2 | 61.2 | 61.2 | 61.2 | 61.2 | 61.3 |
| filler | | | | | | | | | |

### Synthesis of Liquid Polyamide (Polyamide 1 and Polyamide 2)

A list of reagents used in the synthesis of Polyamides 1 and 2 is provided in Table 4 and the synthesis formulation and conditions are summarized in Table 5.

TABLE 4
Materials used for synthesis of Liquid Polyamides

| | Material | Description | Supplier | Location |
|---|---|---|---|---|
| Diacid | Pripol 1013 | Dimer acid, | Croda | Delaware, US |
| | | long chain | | |
| | | diacid (Eq. | | |
| | | Wt 287.7) | | |
| Diamine 1 | Ethylene- | ReagentPlus ®, | Alfa Aesar | Haverhill, |
| | diamine | ≥99% | | MA, US |
| Diamine 2 | Piperazine | ReagentPlus ®, | Sigma | St. Louis, |
| | | 99% | Aldrich | MO, US |
| Catalyst | Phosphoric | 85% Phosphoric | J.T. Baker | Center |
| | Acid | Acid | | Valley, |
| | | | | PA, US |

TABLE 5
Formulation for synthesis of Polyamides 1 and 2

| | | | | | Catalyst |
|---|---|---|---|---|---|
| | | Diacid | Diamine | | 85% |
| | Synthesis | Pripol | Ethylene | | Phosphoric |
| | Temp | 1013 | diamine | Piperazine | Acid |
| Poly- | 225° C. | 100 mol % | 5 mol % | 95 mol % | 300 ppm |
| amide 1 | | | | | |
| Poly- | 225° C. | 100 mol % | 5 mol % | 95 mol % | 300 ppm |
| amide 2 | | | | | |

The synthesis of liquid polyamides was conducted in a 1 L reactor. Isopropanol (IPA) was used to clean the kettle before charging the raw material followed by drying the chamber with heat under vacuum. The target batch temperature was set to 150° C. Once the batch temperature reached 150° C., the batch temperature set-point was increased to 177˜182° C. to let the vapor reach overhead. When the vapor reached the overhead, the overhead temperature gradually increased to 100° C. Approximately 80˜90% of the theoretical amount of water was collected from the distillation. After the overhead temperature decreased, and after another 5 minutes, the target batch temperature was set to 225° C. The overhead temperature gradually increased and then decreased again. After 5 minutes, full vacuum (1˜2 torr) was pulled in the chamber. The torque gradually increased and levelled off. When the torque levelled, the chamber was vented to atmosphere pressure. About 10 lbs of resin was drained into an aluminum pan covered with release liner.

Polyamide 1 was synthesized using a diamine and a diacid with a mole ratio of 2.5 to 1. This yielded an equivalent molecular weight of 637.0 g/eq, where the chain was terminated with amine. Polyamide 2 was synthesized using a diamine and a diacid with a mole ratio of 1.8 to 1. This yielded an equivalent molecular weight of 756.9 g/eq, where the chain was terminated with amine. The amine end-groups of both Polyamide 1 and

Polyamide 2 were comprised of 95 mol % secondary amine and 5 mol % primary amine.

TABLE 6
Properties of Polyamides 1 and 2

| | | | Viscosity @ |
|---|---|---|---|
| | Diamide: Diacid | Equivalent | 25° C. and |
| | mole ratio | Mn (g/eq) | 100 rad/sec (Poise) |
| Polyamide 1 | 2.5 | 637 | 1666 |
| Polyamide 2 | 1.8 | 756.9 | 4237 |

### Test Procedures

### Rheology of Parts A and B

Viscosity was measured using a parallel-plate geometry at 1% strain on a ARES Rheometer (TA Instruments, Wood Dale, Ill., US) equipped with a forced convection oven accessory, atangular frequencies ranging from 10-500 rad/s at 25° C. or through a temperature sweep from 25° C. to 65° C., taking measurements every 10° C.

### Overlap Shear Adhesion (OLS)

Two 0.5 inch (1.27 cm) wide×4 inch (10 cm) long×0.125 inch (0.32 cm) thick aluminum coupons were cleaned using methyl ethyl ketone (MEK) and otherwise left untreated. At the tip of one coupon, a 0.5 inch by 0.5 inch (1.27 cm×1.27 cm) square was covered by the mixed polyamide/epoxy paste and then laminated with another coupon in the opposite tip direction to give about 10-30 mils (0.25-0.76 mm) of paste between the aluminum coupons. The laminated aluminum coupons were then cured at one of the following sets of conditions: room temperature for 24 hours, room temperature for 15 hours, and 100° C. for 1 hour, to give complete curing. The sample was then conditioned at room temperature for 30 min prior to overlap shear testing.

OLS tests were conducted on an Instron Universal Testing Machine model 1122 (Instron Corporation, Norwood, Mass., US) according to the procedures of ASTM D1002-01, “Standard Test Method for Apparent Shear Strength of Single-Lap-Joint Adhesively Bonded Metal Specimens by Tension Loading (Metal-to-Metal).” The crosshead speed was 0.05 inch/min.

### Tensile Properties

For tensile tests, dogbone-shaped samples were made by pressing the mixed paste into a dogbone-shaped silicone rubber mold, which was then laminated with release liner on both sides. The dogbone shape gives a sample with a length of about 0.6 inch in the center straight area, a width of about 0.2 inch in the narrowest area, and a thickness of about 0.06˜0.1 inch. Samples were then cured at room temperature for 24 hours, room temperature for 15 hours, or 100° C. for 1 hour to be fully cured prior to tensile testing.

Tensile tests were conducted on an Instron Universal Testing Machine model 1122 (Instron Corporation, Norwood, Mass., US) according to ASTM D638-03, “Standard Test Method for Tensile Properties of Plastics.” The crosshead speed was 0.05 inch/min.

### Thermal Conductivity

For thermal conductivity measurements, disk-shaped samples were made by pressing the mixed paste into a disk-shaped silicone rubber mold which was then laminated with release liner on both sides. The disk shape gives samples with a diameter of 12.6 mm and a thickness of 2.2 mm. The sample was then cured at room temperature for 24 hours, room temperature for 15 hours, or 100° C. for 1 hour to give complete curing.

Specific heat capacity, cₚ, was measured using a Q2000 Differential Scanning calorimeter (TA Instruments, Eden Prairie, Minn., US) with sapphire as a method standard.

Sample density was determined using a geometric method. The weight (m) of a disk-shaped sample was measured using a standard laboratory balance, the diameter (d) of the disk was measured using calipers, and the thickness (h) of the disk was measured using a Mitatoyo micrometer. The density, ρ, was calculated by ρ=m/(π·h·(d/2)²).

Thermal diffusivity, α(T), was measured using an LFA 467 HYPERFLASH Light Flash Apparatus (Netzsch Instruments, Burlington, Mass., US) according to ASTM E1461-13, “Standard Test Method for Thermal Diffusivity by the Flash Method.”

Thermal conductivity,k, was calculated from thermal diffusivity, heat capacity, and density measurements according the formula:

k=α19 cₚ·ρ

where k is the thermal conductivity in W/(m K), a is the thermal diffusivity in mm²/s, cₚ is the specific heat capacity in J/K-g, and ρ is the density in g/cm³.

### Results

### Rheology of Parts A and B

Viscosity values of individual polyamide components (Part A) and epoxy components (Part B) are listed in Table 7 as a function of angular frequency and temperature.

A comparison of Example 6-Part A and Example 8-Part A demonstrate that 2% by weight of dispersant to filler was very efficient in reducing the viscosity of the polyamide-containing parts, particularly at lower shear rate. The filled systems behaved like Newtonian fluids and did not exhibit shear-thinning. The same effect was also observed for epoxy-containing parts (Example 7-Part B and Example 8-Part B), which exhibited reduced viscosity and Newtonian behavior upon adition of dispersant. Higher temperatures yielded lower viscosity values for all formulations with or without dispersant.

TABLE 7
Viscosity of Polyamide Component (Part A) and Epoxy Component (Part B)

| | Rheometer | Viscosity @ | Viscosity @ | Viscosity @ | Viscosity@ | Viscosity @ |
|---|---|---|---|---|---|---|
| | Temperature | 10.0 rad/s | 50.1 rad/s | 100.0 rad/s | 251.2 rad/s | 501.2 rad/s |
| Example | (° C.) | (poise) | (poise) | (poise) | (poise) | (poise) |
| 6-Part A | 25 | 12253 | 3048 | 2530 | 2179 | 2099 |
| 6-Part A | 45 | 13127 | 3666 | 2387 | 1509 | 1246 |
| 6-Part A | 65 | 45358 | 7918 | 4282 | 2294 | 1723 |
| 8-Part A | 25 | 1550 | 1331 | 1292 | 1264 | 1275 |
| 8-Part A | 45 | 386 | 303 | 287 | 274 | 273 |
| 8-Part A | 65 | 136 | 100 | 92 | 86 | 85 |
| 7-Part B | 25 | 46008 | 13518 | 7716 | 5762 | 5848 |
| 7-Part B | 45 | 2247 | 619 | 534 | 474 | 459 |
| 7-Part B | 65 | 1545 | 261 | 193 | 151 | 138 |
| 8-Part B | 25 | 4832 | 4365 | 4251 | 4133 | 4152 |
| 8-Part B | 45 | 530 | 425 | 400 | 379 | 377 |
| 8-Part B | 65 | 127 | 95 | 87 | 81 | 79 |

### Physical Properties: Thermal Conductivity, Lap Shear Strength, Tensile Strength, and Elongation

Table 8 shows results of the OLS tests for Examples 2 and 3. Part A in Example 2 included Versamid 115 (Polyamide 4) and its viscosity was about 4000 poise at 25° C., whereas Part A in Example 3 included Versamid 150 (Polyamide 3) and its viscosity was only 30 poise at 25° C. The OLS on aluminum coupons for Example 3 was much higher than Example 2, 10.2 N/mm² versus 1.9 N/mm². It is believed that, a lower viscosity may provide better surface wetting, thereby building higher adhesion; and can increase the curing rate thus enhancing the overlap shear strength.

TABLE 8
Lap Shear Strength of Examples 2 and 3

| | | | | OLS on Al |
|---|---|---|---|---|
| | | | | after 24 |
| | | Viscosity of | | hr @ room |
| | | polyamide at | Curing | temperature |
| Example | Polyamide | 25° C. (Poise) | Condition | (N/mm²) |
| 2 | VERSAMID 115 | 4000 | r.t. 24 hrs | 1.9 |
| 3 | VERSAMID 150 | 30 | r.t. 24 hrs | 10.2 |

Thermal conductivity and OLS adhesion for Examples 4 and 5 are provided in Table 9. Example 5 demonstrated a higher thermal conductivity value than Example 4. Without being bound by theory, this may be attributed to the lower density of ATH (Filler 1) compared to TM1250 (Filler 2); at an equivalent percentage, Filler 1 will constitute a higher volume percentage of the composition than Filler 2. In addition, the particle size of Filler 1 is larger than that of Filler 2; therefore, forming the percolation pathway is much easier in formulations containing Filler 1 compared with formulations containing Filler 2. The OLS on aluminum coupons of Example 5 with Filler 1 is also higher than Example 4 with Filler 2.

TABLE 9
Thermal Conductivity and OLS Adhesion on Aluminum Substrates

| | | | | | | Thermal | |
|---|---|---|---|---|---|---|---|
| | | | Thermal | | Heat | Conductivity | |
| | Volume % | Curing | diffusivity | Density | Capacity | (W/(m*K) | OLS (Al) |
| Example | Filler | condition | (mm²/s) | (g/cm³) | J/(C · g) | (estimated) | (N/mm²) |
| 4 | 50.6 | r.t. 24 hrs | 0.66 | 2.39 | 0.91 | 1.44 | 8.0 |
| 5 | 61.2 | r.t. 24 hrs | 0.72 | 1.73 | 1.22 | 1.52 | 13.3 |

Table 10 compares the physical properties of compositions prepared using the commercially available polyamides (Polyamide 3 and Polyamide 4) with synthesized liquid polyamides which include tertiary amides in the backbone (Polyamide 1 and Polyamide 2). Examples CE9, CE10, and CE11, which were made using Polyamide 3, exhibited low elongation. However, comparing Comparative Examples CE9 and CE10 demonstrates that the shear adhesion to the aluminum substrates is significantly reduced after increasing the amount of toughener in the formulation.

Polyamides 1 and 2, which contains tertiary amide in the backbone, can efficiently improve the toughness while maintain good adhesion to aluminum. That is due to containing tertiary amide as majority in backbone to provide chain flexibility and at the same time good adhesion with metal surfaces. As shown in Table 10, unlike the other tougheners, the liquid polyamide provides tertiary amide linkages that provide adhesion to metal surfaces.

Example 12, which was prepared using only Polyamide 2 in the amine component, exhibited an elongation at break over 100%, but with a relatively low tensile strength. Examples 13-15 include a combination of Polyamide 3 and Polyamide 2. All of these examples exhibited good adhesion to aluminum substrates (OLS tests), good tensile strength, and excellent elongation at break. The filler loading in Examples 12-15 was approximately 80 wt% (61.2 vol %), which provided a thermal conductivity around 1.5 W/(m*K). Polyamide 2 appears to provide good elongation at break, which may be due to low hydrogen bonding density and crosslinking density, while Polyamide 3 provides good cohesion for tensile strength and adhesion due to the high hydrogen bonding density. Examples 13-15 contains Polyamide 3 in amounts of 5 wt%, 10 wt% and 20 wt% of total polyamide, respectively. With the increase of Polyamide 3, the OLS on aluminum coupons increased from 5.2 N/mm² (Example 12) to 14.5 N/mm² (Example 15), and the tensile strength increased from 1.8 N/mm² (Example 12) to 9.0 N/mm² (Example 12), while the elongation at break decreased from 101.7% (Example 12) to 14% (Example 15).

TABLE 10
OLS and tensile test results for formulations with different
tougheners and combination of Polyamide 2 and Polyamide 3

| | | | Polyamide | | | Tensile | Elongation |
|---|---|---|---|---|---|---|---|
| | | VERSAMI:Tough- | 3:Polyamide 2 | Curing | OLS (Al) | Strength | at break |
| Ex. | Toughener | ener (wt:wt) | Ratio (wt:wt) | Condition | (N/mm²) | (N/mm²) | (%) |
| CE9 | PRIPOL | 90:10 | 100:0 | r.t. 15 hrs + | 10.4 | 8.5 | 2.8 |
| | 2033 | | | 60° C. 1 hr | | | |
| CE10 | PRIPOL | 80:20 | 100:0 | r.t. 15 hrs + | 8.5 | 5.7 | 5.5 |
| | 2033 | | | 60° C. 1 hr | | | |
| CE11 | EM505- | 90:10 | 100:0 | r.t. 15 hrs + | 11.7 | 15.8 | 1.1 |
| | G20 | | | 60° C. 1 hr | | | |
| 12 | — | — | 0:100 | 1 hr | 5.2 | 1.8 | 101.7 |
| | | | | @100° C. | | | |
| 13 | — | — | 5:95 | 1 hr | 8.7 | 2.2 | 62.1 |
| | | | | @100° C. | | | |
| 14 | — | — | 10:90 | 1 hr | 9.7 | 4.3 | 33.0 |
| | | | | @100° C. | | | |
| 15 | — | — | 20:80 | 1 hr | 14.5 | 9.0 | 14.0 |
| | | | | @100° C. | | | |

Table 11 summarized lap shear and tensile test results for formulations having different polyamides with tertiary amide backbones with and without filler. The viscosity of the polyamide with tertiary amide in the backbone appears to affect the adhesion performance and tensile properties of the composition. Example 16 included Polyamide 1, which has a lower viscosity than Polyamide 2 (Table 6), which was included in Example 14. The OLS on aluminum substrates increases from 4.3 N/mm² (Example 14) to 7.3 N/mm² (Example 16) while the elongation decreases from 33% (Example 14) to 24.8% (Example 16).

The results for Example 1 demonstrate that a composition without fillers yields OLS on aluminum of 16.9 N/mm², tensile strength of 10.4 N/mm², and elongation at break of 400%.

TABLE 11
OLS and tensile test results for formulations with
Polyamide 1 and Polyamide 2 with and without filler

| | | | | OLS | Tensile | Elon- |
|---|---|---|---|---|---|---|
| | Polyamide | Filler | | (Al) | Strength | gation |
| | Type | Volume | Curing | (N/ | (N/ | at break |
| Ex. | and Ratio | % | Condition | mm²) | mm²) | (%) |
| 14 | Polyamide 2/ | 61.2 | 1 hr | 9.7 | 4.3 | 33.0 |
| | Polyamide 3 | | @100° C. | | | |
| | (90:10 wt:wt) | | | | | |
| 16 | Polyamide 1/ | 61.2 | 1 hr | 12.8 | 7.3 | 24.8 |
| | Polyamide 3 | | @100° C. | | | |
| | (90:10 wt:wt) | | | | | |
| 1 | Polyamide 1/ | 0 | 1 hr | 16.9 | 10.4 | 400.0 |
| | Polyamide 3 | | @ 100° C. | | | |
| | (90:10 wt:) | | | | | |

Table 12 summarizes the curing kinetics of formulations with and without multifunctional amine (Amine 1, DYTEK A) and with either Accelerator 1 or Accelerator 2 or catalyst. The results clearly show that Example 18 has a higher curing rate than Example 17.

TABLE 12
OLS test results for formulations with and without Amine 1 and with
different catalysts at various curing times at room temperature

| | | | OLS (Al) (N/mm²) | | | |
|---|---|---|---|---|---|---|
| | | | r.t. | r.t. | r.t. | r.t. |
| Ex. | Amine | Catalyst | 8 hrs | 24 hrs | 48 hrs | 96 hrs |
| 17 | N/A | DBU | 0.04 | 1.8 | 3.9 | 10.8 |
| 18 | Amine 1 | Calcium | 2.5 | 5.6 | 8.9 | 10 |
| | | triflate | | | | |

In addition, reactive diluents can be added into Parts A and B to reduce the viscosity. Amine 1, a difunctional amine, has been included in Part A of Example 19. Table 13 shows that the viscosity of part A of Example 18 is 2,206,200 cps, whereas the viscosity of Part A of Example 19 is 340,900 cps. Part B of Example 19, which includes Epoxy 2, also has reduced viscosity compared to Part B of Example 18.

TABLE 13
OLS, tensile, TC and viscosity results on formulations
with or without reactive diluents in both parts.

| | | | Tensile | Elon- | | Viscosity | Viscosity |
|---|---|---|---|---|---|---|---|
| | Filler | OLS | Strength | gation | | Part A at | Part B at |
| | Vol | (N/ | (N/ | at break | TC | 100 rad/s, | 100 rad/s, |
| Ex. | % | mm²) | mm²) | (%) | (W/mK) | r.t. (cps) | r.t. (cps) |
| 18 | 51.2 | 10 | 5.5 | 66 | 1.1 | 2,206,200 | 140,000 |
| 19 | 51.4 | 5.2 | 4.1 | 33 | 1.2 | 340,900 | 14,000 |

Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows. All references cited in this disclosure are herein incorporated by reference in their entirety.

1. A curable composition comprising:
a polyamide composition comprising a polyamide, the polyamide comprising a tertiary amide in the backbone thereof and being amine terminated; and
an epoxy composition comprising an epoxy resin.

2. The curable composition of claim 1, wherein tertiary amides are present in the polyamide in an amount of at least 50 mol %, based on the total amide content present in the polyamide backbone.

3. The curable composition according to claim 2, further comprising an inorganic filler present in an amount of at least 20 volume%, based on the total volume of the curable composition.

4. The curable composition according to claim 3, the polyamide composition further comprising a second polyamide, wherein the second polyamide comprises a multifunctional polyamidoamine.

5. A curable composition comprising:
a polyamide composition comprising
a first polyamide component comprising the reaction product of
(i) a diacid; and
(ii) a diamine, wherein the diamine comprises a secondary diamine or a secondary/primary hybrid diamine;
wherein the first polyamide component comprises a tertiary amide in the backbone thereof and is amine terminated; and
a second polyamide component; and
an epoxy composition comprising an epoxy resin.

6. The curable composition according to claim 5, wherein the mole ratio of diamine to diacid in the first polyamide component is between 1.2 and 3.

7. The curable composition according to claim 5, wherein
the diamine has a formula R1-NH—R2-NH—R1;
the R2 group is an alkylene, branched alkylene, cycloalkylene, substituted or unsubstituted arylene, heteroalkylene, or heterocycloalkylene; and
(i) each R1 group, independently, is a linear or branched alkyl, cycloalkyl, aryl, heteroalkyl, heteroaryl, or hydrogen atom, with the proviso that both R1s are not hydrogen atoms, or
(ii) the R1 groups are alkylene or branched alkylene and form a heterocyclic compound.

8. The curable composition according to claim 7, wherein the diamine comprises piperazine.

9. The curable composition according to claim 5, wherein the second polyamide component comprises a multifunctional polyamidoamine.

10. The curable composition according to claim 5, wherein the first polyamide component is present in the polyamide composition in an amount of at least 50 wt. %, based on the total weight of polyamide in the polyamide composition.

11. The curable composition according to claim 5, wherein the diacid comprises at least 80 mol % long chain diacid, based on the total moles of the diacid.

12. The curable composition according to claim 5, wherein the diacid comprises a dicarboxylic dimer acid.

13. The curable composition according to claim 5, further comprising an inorganic filler present in an amount of at least 20 volume %, based on the total volume of the curable composition.

14. The curable composition according to claim 5, wherein epoxy resin is present in the epoxy composition in an amount of at least 15 wt. %, based on the total weight of the epoxy composition.

15. The curable composition according to claim 14, wherein polyamides are present in the polyamide composition in an amount of at least 15 wt. %, based on the total weight of the polyamide composition.

16. (canceled)

17. A curable composition comprising:
a polyamide;
an epoxy resin; and
an inorganic filler present in the curable composition in an amount of at least 20 volume %, based on the total volume of the curable composition;
wherein the curable composition provides, upon curing, (i) an elongation at break of greater than 5.5%, and (ii) an overlap shear strength of 5-20 N/mm².

18. The curable composition according to claim 17, wherein the curable composition provides, upon curing, a tensile strength of 0.5 to 16 N/mm2.

19. (canceled)

20. (canceled)

21. The curable composition according to claim 20, wherein the polyamide comprises a tertiary amide in the backbone thereof and is amine terminated.

22-26. (canceled)

27. An article comprising a cured composition, wherein the cured composition is the reaction product of the curable composition according to claim 5.

28-31. (canceled)

32. A battery module comprising a plurality of battery cells connected to a first base plate by a first layer of a curable composition according to claim 5.

33. (canceled)
